(19) United States
(12) Patent Application Publication
(10) Pub. No.: US 2022/0414644 A1
(43) Pub. Date: Dec. 29, 2022

(54) CASHLESS PAYMENT SYSTEM AND INFORMATION TERMINAL

(71) Applicant: Maxell, Ltd., Kyoto (JP)

(72) Inventors: Yasunobu HASHIMOTO, Kyoto (JP); Naohisa TAKAMIZAWA, Kyoto (JP); Masuo OKU, Kyoto (JP)

(73) Assignee: Maxell, Ltd., Kyoto (JP)

(21) Appl. No.: 17/777,616

(22) PCT Filed: Nov. 18, 2019
(86) PCT No.: PCT/JP2019/045134

§ 371 Date: May 18, 2022

(51) Int. Cl. G06Q 20/32; G06Q 20/40; G06Q 20/42; G02B 27/01

(52) U.S. Cl. CPC G06Q 20/3276; G06Q 20/407; G06Q 20/42; G02B 27/017; G02B 2027/0178

(57) ABSTRACT

A technique in which with respect to cashless payment technique, suitable cashless payment can be carried out with less operation by a user who is a purchaser is provided. An information terminal is configured to: photograph, by a camera, a code of payment destination information posted by a store and a payment amount corresponding to a purchase amount of a product or service on a basis of an operation of a user; issue a payment command in a case where both payment destination information and the payment amount are recognized on a basis of a photographed image, the payment command including the payment destination information and the payment amount; and transmit the payment command to a server to cause the server to execute the cashless payment processing.

### TECHNICAL FIELD

The present invention relates to a technique of a cashless payment system and an information terminal.

### BACKGROUND ART

In recent years, when a user who is a purchaser at a store makes a payment associated with a purchase of a product or service, in other words, when the user pays a purchase amount, a case of carrying out a payment that do not require cash using an information terminal such as a smartphone (referred to also as a “cashless payment”) is increased. As the cashless payment, there are a method of using a device on which an IC chip having a non-contact and short-range communication function such as NFC (Near Field Communication), and a method of reading a code such as a QR (Quick Response) code (registered trademark) by a camera of an information terminal. As the latter method, there are a store scanning method and a user scanning method, and there are advantages such as the ability to retrofit functions to smartphones that have already been sold.

The store scanning method is a method of displaying a QR code on a display screen of a smartphone of a purchaser and reading the QR code by equipment on a store side. The user scanning method is a method of posting a QR code by a store side, and reading the QR code by a camera provided in a smartphone of a user who is a purchaser. The store scanning method tends to relatively increase an introduction cost of equipment on the store side. On the other hand, in the user scanning method, in a case where a fixed QR code is used, an introduction cost of a cashless payment becomes low. The fixed QR code does not include amount information of a product as coded information, but includes information regarding a store, in other words, includes only information regarding a payment destination and a seller.

As an example of a conventional technique regarding the cashless payment described above, Japanese Patent Application Laid-Open Publication No. 2018-116499 (Patent Document 1) can be mentioned. Patent Document 1 describes that as a technique such as an unmanned sales method that can simplify a user's operation for purchasing a product, a terminal device reads first identification information, and accepts an operation of determining a purchase amount of a product.

### RELATED ART DOCUMENTS

### Patent Documents

Patent Document 1: Japanese Patent Application Laid-Open Publication No. 2018-116499

### SUMMARY OF THE INVENTION

### Problems to be Solved by the Invention

The technique of Patent Document 1 can be said to be one example of a cashless payment system of the user scanning method in which a fixed QR code is displayed. In this technique, a purchaser carries out an operation of correcting a purchase amount and a basic amount on a smartphone from seller information read from the QR code, in other words, store information and basic amount information obtained from a server, and makes a payment. In the conventional techniques including Patent Document 1, at the time of a cashless payment, a user is required to carry out an input operation or a correction operation regarding the amount, and the user feels troublesome such operations. At the time of the cashless payment, it is preferable that the user does not have to take the trouble of operation from the viewpoint of convenience, efficiency, ease of popularization, and the like. In the conventional technique, there is room for examination and improvement regarding the time and effort of operations, and it is desirable to provide a cashless payment method by which it is possible to further reduce the operations.

Further, the technique of Patent Document 1 shows a payment method in an unmanned store with a small variation in product amounts, and does not show a payment method in a manned store with a large variation in product amounts. It is desirable to provide a cashless payment method that can be suitably applied regardless of store attributes such as manned stores or unmanned stores as well as the time and effort required for operations.

It is an object of the present invention to provide a technique in which with respect to a cashless payment technique, a suitable cashless payment can be carried out with less operation by a user who is a purchaser.

### Means for Solving the Problem

A representative embodiment of the present invention has a configuration as follows. A cashless payment system according one embodiment for executing a cashless payment associated with purchase of a product or service by a user at a store. An information terminal having a camera and a cashless payment function is connected by communication to a server executing cashless payment processing in the cashless payment system. The user who is a purchaser uses the information terminal. The information terminal is configured to: photograph, by the camera, a code of payment destination information posted by the store and a payment amount corresponding to a purchase amount of the product or service on a basis of an operation of the user; issue a payment command in a case where both the payment destination information and the payment amount are recognized on a basis of a photographed image, the payment command including the payment destination information and the payment amount; and transmit the payment command to the server to cause the server to execute the cashless payment processing.

### Effects of the Invention

According to the representative embodiment of the present invention, with respect to a cashless payment technique, a suitable cashless payment can be carried out with less operation by a user who is a purchaser.

### BRIEF DESCRIPTIONS OF THE DRAWINGS

FIG. 1 illustrates a configuration of a cashless payment system according to a first embodiment of the present invention;

FIG. 2 illustrates a display screen example of an information terminal according to the first embodiment;

FIG. 3 illustrates a configuration example of the information terminal according to the first embodiment;

FIG. 4 illustrates a processing flow by an application of the information terminal according to the first embodiment;

FIG. 5 illustrates a display screen example of an information terminal in a cashless payment system according to a second embodiment of the present invention;

FIG. 6 illustrates a processing flow by an application of the information terminal according to the second embodiment;

FIG. 7 illustrates a configuration of a cashless payment system according to a third embodiment of the present invention;

FIG. 8 illustrates a display screen example of the information terminal according to the third embodiment;

FIG. 9 illustrates a processing flow by an application of the information terminal according to the third embodiment;

FIG. 10 illustrates a configuration of a cashless payment system according to a fourth embodiment of the present invention;

FIG. 11 illustrates a display screen example of an HMD and a wearable terminal according to the fourth embodiment;

FIG. 12 illustrates an appearance configuration example of the HMD according to the fourth embodiment;

FIG. 13 illustrates a configuration example of the HMD according to the fourth embodiment;

FIG. 14 illustrates a processing flow by an application of the HMD according to the fourth embodiment;

FIG. 15 illustrates a configuration of a cashless payment system according to a fifth embodiment of the present invention;

FIG. 16 illustrates an example of a display screen of an HMD in a cashless payment system according to a sixth embodiment of the present invention;

FIG. 17 illustrates a processing flow by an application of the HMD according to the sixth embodiment;

FIG. 18 illustrates an example of a display screen in a cashless payment system according to a seventh embodiment of the present invention;

FIG. 19 illustrates a processing flow by an application of an information terminal in the cashless payment system according to an eighth embodiment of the present invention;

FIG. 20 illustrates a processing flow by an application of an information terminal in a cashless payment system according to a modification example of the first and eighth embodiments;

FIG. 21 illustrates a processing flow by an application of an information terminal in a cashless payment system according to a nineth embodiment of the present invention;

FIG. 22 illustrates an example of a display screen of the information terminal according to the nineth embodiment;

FIG. 23 illustrates an example of a display screen of an information terminal according to a modification example of the nineth embodiment;

FIG. 24 illustrates a configuration of a cashless payment system according to a tenth embodiment of the present invention;

FIG. 25 illustrates a processing flow of an application of an information terminal according to the tenth embodiment;

FIG. 26 illustrates an example of a display screen of the information terminal according to the tenth embodiment; and

FIG. 27 illustrates a configuration of a cashless payment system according to an eleventh embodiment of the present invention.

### DETAILED DESCRIPTION OF EMBODIMENTS

Hereinafter, embodiments of the present invention will be described in detail with reference to the drawings. Note that in all of the drawings for explain the embodiments, in principle, the same reference numeral is assigned to the same unit, and repeated explanation thereof will be omitted.

### First Embodiment

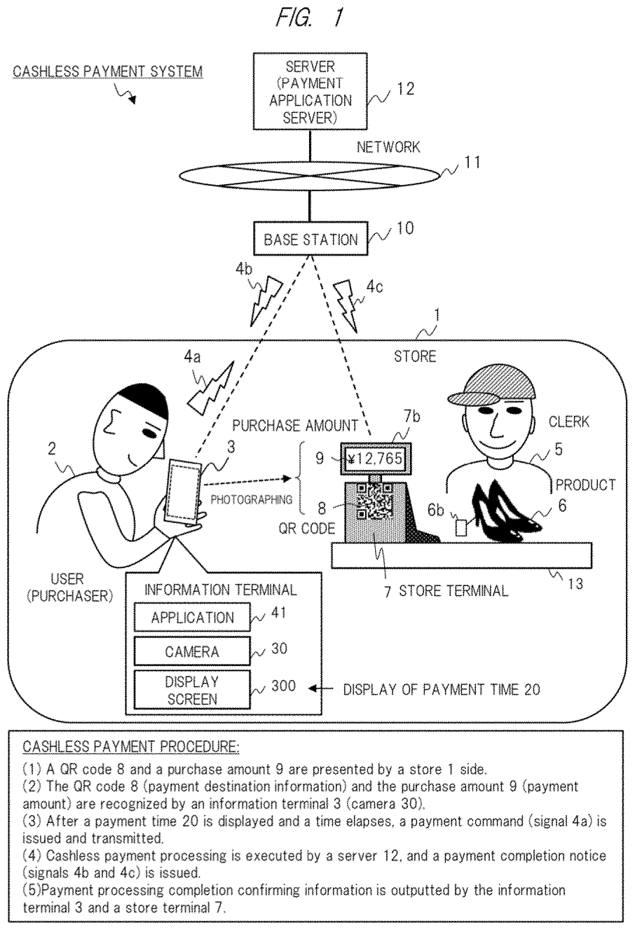

A cashless payment system and the like according to a first embodiment of the present invention will be described with reference to FIG. 1 to FIG. 4. An information terminal according to the first embodiment is an information terminal constituting a cashless payment system according to the first embodiment.

[Outline]

In a cashless payment method of an example of the conventional technique, for example, in case of a user scanning method, a QR code is posted in the vicinity of a store terminal in a store, and a purchase amount (corresponding payment amount) of a product or the like is displayed on a display device of the store terminal. A user who is a purchaser reads the QR code by a cashless payment application and a camera of an information terminal such as a smartphone, carries out an input operation of the payment amount to execute a cashless payment.

On the other hand, in the cashless payment system according to the first embodiment, a store side posts a QR code obtained by coding information containing payment destination information in the vicinity of a store terminal, for example, and displays a payment amount corresponding to a purchase amount of a product or the like on a display device of the store terminal. A user who is a purchaser photographs two of the QR code and the payment amount by a camera of an information terminal. In a case where a cashless payment application of the information terminal recognizes two kinds of information, containing the payment destination information of the QR code and the payment amount from a photographed image, an image of a predetermined payment time is displayed on a display screen, a payment command is issued automatically after the payment time expires, and a server is caused to execute cashless payment processing. The information terminal displays payment processing completion confirming information received from the server on the display screen. Further, in a case where a store is a manned store, the store terminal displays the similar payment processing completion confirming information received from the server on a display screen. In case of the manned store, both a purchaser and a clerk confirm the payment processing completion confirming information. In case of an unmanned store, only the purchaser confirms the payment processing completion confirming information. As a result, the cashless payment system according to the first embodiment eliminates the trouble of the user's operation in case of the user scanning method, in particular, the trouble of inputting or correcting the amount, and can realize an easy-to-use and suitable cashless payment.

[1-1: Cashless Payment System]

FIG. 1 illustrates a configuration of a cashless payment system according to the first embodiment and an outline of a procedure of a cashless payment. In FIG. 1, the cashless payment system includes an information terminal 3 operated by a user who is a purchaser 2 in a store 1, a store terminal 7 operated by a clerk 5 who is a cashier at a checkout counter 13, a base station 10, a network 11 that is a communication network including the Internet and the like, and a server 12 that is a payment application server, and these are appropriately connected to each other by communication. A case where the store 1 is a manned store where products 6 are sold will be described. The purchaser 2, the information terminal 3, the checkout counter 13, the clerk 5, the store terminal 7, and the products 6 are present in the store 1. Note that each of the information terminal 3 and the store terminal 7 may have a plurality of unit each having the similar function.

The purchaser 2 is a user who purchases the product 6 or service in the store 1, and carries out a cashless payment using the information terminal 3 in order to pay a purchase amount of the product 6. The information terminal 3 is a cashless payment terminal carried by the user and having a cashless payment function, and is a smartphone, for example. However, it may be another type of device. An application 41 is a cashless payment application having a cashless payment function, and is an application program that executes a specific process while cooperating with the server 12 by communication. The user installs the application 41 on the information terminal 3 in advance. The application 41 may be provided from the server 12.

The base station 10 is a mobile communication base station connected to the network 11, and may be an access point for a wireless LAN. The information terminal 3 and the store terminal 7 can be connected to the network 11 through the base station 10, and can communicate with the server 12. The server 12 is a payment application server that is connected to the network 11, and has a function of executing cashless payment processing in response to a payment command from the application 41 of the information terminal 3. After the cashless payment processing is completed, the server 12 transmits payment processing completion confirming information to the information terminal 3 and the store terminal 7. Note that each of the application 41 of the information terminal 3 and the store terminal 7 knows address information for communicating with the server 12. The address information may be described in a QR code 8.

Signals 4a and 4b are examples of communication signals associated with wireless communication between the information terminal 3 and the base station 10. A signal 4c is an example of a communication signal associated with wireless communication between the store terminal 7 and the base station 10. For example, the signal 4a is a payment command to be transmitted from the information terminal 3 to the server 12. The signal 4b is the payment processing completion confirming information to be transmitted from the server 12 to the information terminal 3. The signal 4c is the payment processing completion confirming information to be transmitted from the server 12 to the store terminal 7. The payment processing completion confirming information of the signal 4b and the payment processing completion confirming information of the signal 4c contain the same key code (corresponding to a payment completion ID), which will be described later. In this configuration example, as necessary for a cashless payment, the server 12 and the information terminal 3 communicate with each other, and the server 12 and the store terminal communicate with each other. Normally, those communication connections are not required. Note that as a modification example, a form in which communication is not executed between the store terminal 7 and the server 12 is also possible. In this case, the signal 4c of the payment processing completion confirming information is not transmitted from the server 12 to the store terminal 7.

The clerk 5 carries out work such as accepting of a cashless payment associated with accounting of the product 6 for the purchaser 2 while operating the store terminal 7. in the checkout counter 13. The store terminal 7 is installed in the checkout counter 13. A tag 6b for management may be attached to the product 6. Information such as a product ID and an amount thereof are described on the tag 6b in the form of a bar code or the like.

The store terminal 7 is a terminal having a payment function including a cashless payment function, in other words, a store-side payment device, and is composed of a cash register or a POS cash register terminal, for example. However, it is not limited to this, and may be configured by a smartphone or a tablet terminal having a payment function. The payment function of the store terminal 7 is a function of accepting a cashless payment from the information terminal 3. The store terminal 7 includes a display device 7b having a display unit (or a display screen) for showing information and images toward the purchaser 2. Although it is not illustrated, the store terminal 7 also has a display unit (or a display screen) for showing information and images toward the clerk 5. Information such as a purchase amount 9 of the product 6 is displayed on the display screen of the display device 7b. The purchase amount 9 corresponds to a total amount regarding one or more products 6 purchased by the purchaser 2, that is, a payment amount associated with a first cashless payment. The purchase amount 9 is image information such as a digit string that can be understood by a person.

The QR code 8 is a two-dimensional code that is at least posted at any position in the store 1. In the present embodiment, the QR code 8 is posted on a part of a housing of the store terminal 7 on a surface facing the purchaser 2 in the form of pasting as a printed matter such as a seal. The QR code 8 is a coded version of information containing store information of this store 1, in other words, payment destination information. More specifically, the payment destination information may be information of a transfer destination account. It is not limited to the QR code 8, and a code of another method may be applied. The QR code 8 may be an image that is displayed on the display screen as another mode. For example, an image of the QR code 8 may be displayed in parallel with the purchase amount 9 on the display screen of the display device 7b, which has a somewhat large size. A device having an electronic display device such as a tablet terminal may be provided separately from the store terminal 7, and the image of the QR code 8 may be displayed on a display screen of the device. A mode of posting the QR code 8 may be any mode so long as an image corresponding to the QR code 8 can be photographed from a camera 30 of the information terminal 3.

In the example of the first embodiment, a method of photographing two elements of the QR code 8 and the purchase amount 9 as one or more still images by the camera 30 is used. The purchaser 2 appropriately presses a photographing button of the camera 30 as a minimum operation. Further, at the time of photographing, as a first method, both the QR code 8 and the purchase amount 9 may be included in one image at the same time. Alternatively, as a second method, the QR code 8 may first be photographed so that the QR code 8 is included in a first image, and then the purchase amount 9 may be photographed so that the purchase amount 9 is included in a second image. In the first embodiment, the user may adopt either the first method or the second method described above. In case of the still images, the purchaser 2 can redo a photographing operation appropriately if the QR code 8 or the purchase amount 9 cannot be photographed successfully or recognized.

[1-2: Cashless Payment Procedure]

In FIG. 1, an outline of a cashless payment procedure according to the first embodiment is as follows. (1) First, in the store 1, the purchaser 2 brings a product 6 to be purchased to the checkout counter 13, and starts a cashless payment procedure associated with purchase of the product 6 with the clerk 5. The clerk 5 on the store 1 side presents the QR code 8 and the purchase amount 9 to the purchaser 2. A specific example is as follows. The QR code 8 is posted on the store terminal 7 in advance. The clerk 5 carries out an operation of scanning the tag 6b of the product 6 by a bar code reader or the like connected to the store terminal 7, for example. As a result, information of the tag 6b is read, and information on an ID and an amount of the product 6 is inputted into the store terminal 7. Alternatively, in case of a product 6 having no tag 6b, the clerk 5 may carry out an operation of inputting the amount into the store terminal 7. The store terminal 7 displays the purchase amount 9 on the display screen of the display device 7b on the basis of the information on the inputted amount. In the present embodiment, the purchase amount 9 is displayed as “¥12,765”. Note that in a case where the purchaser 2 purchases a plurality of products 6 at once, the clerk 5 repeats the similar operation for each product 6, and the store terminal 7 displays a total amount of the plurality of products 6 on the display device 7b as the purchase amount 9 corresponding to a payment amount.

(2) The purchaser 2 photographs two of the QR code 8 and the purchase amount 9, which are presented, by the camera 30 in a state where the application 41 of the information terminal 3 is started. As a result, the application 41 of the information terminal 3 reads and recognizes two kinds of information containing the QR code 8 and the purchase amount 9 from a photographed image. As a result, the information terminal 3 at least grasps two kinds of information containing payment destination information from the QR code 8 and the payment amount. At this time, in detail, the purchaser 2 may photograph a single still image by the camera 30 so that both the QR code 8 and the purchase amount 9 are captured. Alternatively, the purchaser 2 may photograph respective still images including a first image that is a still image in which the QR code 8 is captured and a second image that is a still image in which the purchase amount 9 is captured. The information terminal 3 extracts two kinds of information of the QR code 8 and the purchase amount 9 from one or more photographed images on the basis of image processing, and obtains information containing the payment destination information from the QR code 8 by decryption.

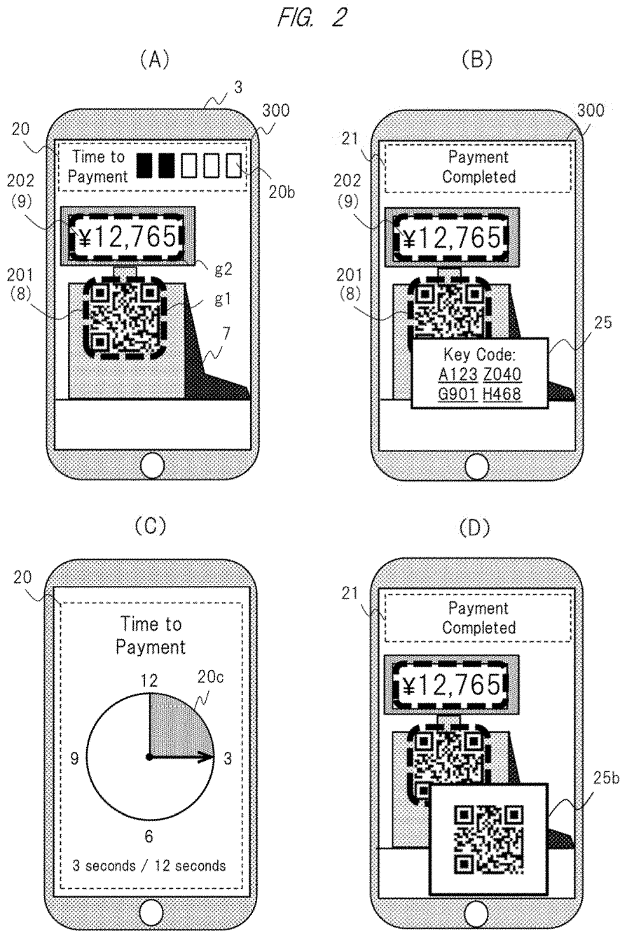

(3) After recognizing the two kinds of information described above, the information terminal 3 displays a predetermined payment time 20 (will be described later with reference to FIG. 2) on a display screen 300. After the payment time 20 has elapsed, the information terminal 3 automatically issues a payment command (the signal 4a) without requiring an operation of the purchaser 2, and transmits it to the server 12. This payment command is a command or request for causing the server 12 to execute cashless payment processing. This payment command includes information on the purchaser 2 and the information terminal 3, the payment destination information, and payment amount information.

(4) The server 12 executes the cashless payment processing on the basis of the information on the payment command received from the information terminal Specifically, the cashless payment processing includes a process of transferring the payment amount from an account of the purchaser 2 to an account of the store 1. With completion of the cashless payment processing, the server 12 transmits the payment processing completion confirming information for the information terminal 3 to the information terminal 3 as the signal 4b, thereby notifying payment completion. At the same time, the server 12 transmits the payment processing completion confirming information for the store terminal 7 to the store terminal 7 as the signal 4c, thereby notifying payment completion. The payment processing completion confirming information contains a payment processing completion confirming message and a key code 25 (will be described later with reference to FIG. 2) that is a payment completion ID.

(5) The information terminal 3 outputs the payment processing completion confirming information received from the server 12 to the purchaser 2, and displays it on the display screen 300, for example. The purchaser 2 confirms the payment processing completion confirming information. Further, the store terminal 7 outputs the payment processing completion confirming information received from the server 12 to the clerk 5, and displays it on a display screen of the clerk 5 side, for example. The clerk 5 confirms the payment processing completion confirming information. As a result, the cashless payment procedure is completed.

Note that in the present embodiment, the store terminal 7 is configured so as to have a function of receiving the payment processing completion confirming information from the server 12 and displaying it on the display screen. As a modification example, the store terminal 7 may be configured so as not to have such a function. In this case, the server 12 does not transmit the payment processing completion confirming information to the store terminal 7, and the clerk 5 of the store 1 does not confirm the payment processing completion confirming information.

[1-3: Display Screen]

FIG. 2 illustrates an example of the display screen 300 of the information terminal 3 at the time of a cashless payment procedure based on the configuration illustrated in FIG. 1. Note that at the time of photograph by the camera 30 based on an operation of the purchaser 2, the information terminal 3 displays a monitor image of the store terminal 7 and the like captured by the camera 30 on the display screen 300. This monitor image is an image whose content changes in accordance with movement of the camera 30. The information terminal 3 captures a still image at that time point in response to an operation in which the purchaser 2 presses a capturing button.

(A) of FIG. 2 illustrates one example of the display screen 300, and includes an example of a still image that is an image photographed by the camera 30 and an example of image information displayed by superimposing or compositing it on the still image. The information terminal 3 detects, by scanning, an area 201 corresponding to the QR code 8 illustrated in FIG. 1 and an area 202 corresponding to the purchase amount 9 from the photographed image, and recognizes payment destination information and a payment amount from these areas. Further, at this time, the information terminal 3 may display an image such as flaming or coloring in each of the recognized area 201 of the QR code 8 and the recognized area 202 of the purchase amount 9. In the present embodiment, a case where images g1 and g2 such as broken line frames are displayed by superimposition or composition is illustrated. This makes it possible to inform the purchaser 2 in an easy-to-understand manner of a state where the QR code 8 and the purchase amount 9 can be recognized.

Moreover, after recognizing the two kinds of information described above, the information terminal 3 displays a payment time 20 in the display screen 300. The payment time 20 is image information as a graphical user interface (GUI) for transmitting a time from immediately after the recognition of the two kinds of information described above to execution of payment and an elapsed state to the purchaser 2. In other words, the payment time 20 is image information representing a grace period until issuance of the payment command. In the present embodiment, an image of the payment time 20 is displayed in an upper area of the display screen 300 by superimposition or composition. In the present embodiment, this payment time 20 is an image that includes a message (“Time to Payment”) representing a payment time and a bar 20b representing a total length of the payment time and the elapsed state. The payment time 20 is a time with the recognition of the two kinds of information described above as a start time point and the issuance of the payment command as an end time point, and is set in advance as a predetermined length. The length of the payment time 20 is set to 5 seconds as an example. Note that the length of the payment time 20 may be displayed in the display screen 300 as an image such as “5 seconds”, for example. The bar 20b is represented by five blocks corresponding to the length of the payment time, for example. Display of one block is updated every one second. In a case where the elapsed state is the elapse of 2 seconds, for example, as illustrated in (A) of FIG. 2, color up to two blocks starting from a left side is updated from a first color (for example, white) to a second color (for example, black), for example. The information terminal 3 starts counting of a timer corresponding to the payment time 20 from a time point when the two kinds of information are recognized, and updates a display state of the bar 20b in accordance with the elapse of time. For example, all the blocks of the bar 20b are the first color at the start time point, but all the blocks of the bar 20b become the second color at the end time point.

The purchaser 2 can grasp the elapsed state until automatic execution of a cashless payment by looking at the payment time 20, can determine whether the payment is to be executed actually or not, and can carry out a cancellation operation during this payment time 20 if necessary. A mode of presenting the payment time 20 is not limited to the example illustrated in (A) of FIG. 2, and the image information may be expressed so that a size of the time and the elapsed state can be easily understood by the purchaser 2. Further, the payment time 20 is not limited to the image display, and an audio output such as a sound effect (for example, a timer count sound effect) may be used in combination.

The information terminal 3 automatically issues the payment command and transmits it to the server 12 at a time point when the payment time 20 is expired. At the time of a control including this payment time 20, it is not necessary for the purchaser 2 to carry out any input operation regarding the purchase amount 9, for example, an input operation of a button by hardware or software. Namely, the purchaser 2 can make a cashless payment only by waiting for the payment time 20 so long as the purchaser 2 carries out the operation of photographing the two kinds of information described above by the camera 30.

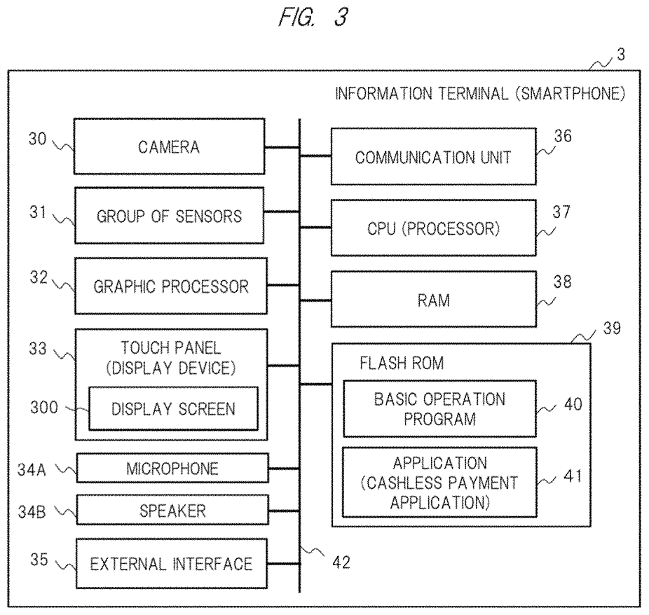

Further, during the lapse of the payment time 20 described above, a predetermined cancellation operation regarding the cashless payment is accepted. The predetermined cancellation operation is a shaking operation in which the user shakes the information terminal 3, for example. In another example, the cancellation operation may be an operation of tilting the information terminal 3 to a certain extent or more, or may be an operation of pressing a predetermined button by hardware or software. In still another example, the cancellation operation may be an operation in which the user points the camera 30 in a direction in which the QR code 8 or the purchase amount 9 as a target is not captured, for example, an operation of maintaining a state where the QR code 8 or the like is not captured for a predetermined time or longer. Any cancellation operation can be detected by using a group of sensors 31 (will be described later with reference to FIG. 3).

(B) of FIG. 2 illustrates an example of the display screen 300 when the cashless payment processing by the server 12 is completed and the payment processing completion confirming information is displayed. When the information terminal 3 receives the payment processing completion confirming information from the server 12, the information terminal 3 generates a message 21 and a key code 25 on the basis of the information, and displays them on the display screen 300. The message 21 is an image of a payment processing completion confirming message (for example, “Payment Completed”) representing that the cashless payment processing is completed. In the present embodiment, the display of the payment time 20 on the image such as the store terminal 7 as in (A) is erased, and the message 21 is then displayed by superimposition or composition. The key code 25 corresponds to the payment completion ID, and is an ID (identification information) that is issued for each payment after the cashless payment processing is completed. In the present embodiment, the key code 25 is composed of four 4-digit character strings (alphanumeric character) as one set. In the present embodiment, the key code 25 is displayed in a lower area of the display screen 300 by superimposition or composition. A key code having the same value is transmitted from the server 12 to both the information terminal 3 and the store terminal 7.

The purchaser 2 can confirm the completion of the cashless payment by confirming the payment processing completion confirming information, specifically, the message 21 and the key code 25 on the display screen 300 illustrated in (B). Further, the application 41 stores information containing the key code 25 in a memory as a log. The purchaser 2 can later refer to and confirm a payment history including the key code 25 and the like from the log on the screen of the application 41. Similarly, the clerk can confirm the completion of the cashless payment regarding the purchaser 2 in front of him or her by confirming the key code of the payment processing completion confirming information displayed on the display screen of the clerk 5 side in the store terminal 7. As an example of a more detailed procedure, the purchaser 2 shows the key code 25 on the screen as illustrated in (B) to the clerk 5, and the clerk 5 confirms whether the key code 25 on the screen in the information terminal 3 side matches the key code on the screen of the store terminal 7 side or not. For example, the clerk 5 confirms whether the last four digits of character strings in both key codes match each other or not. As a result, the purchaser 2 and the clerk 5 can confirm the completion of the cashless payment. Note that when the payment processing completion confirming information is outputted on the screen as illustrated in (B), a predetermined audio output may be used together.

(C) of FIG. 2 illustrates another display example regarding the payment time 20 as a modification example. This example illustrates a case where the payment time 20 is displayed in a large size as an image of an expression such as a clock 20c on a certain background in the display screen 300. The present embodiment illustrates a state where a length of the payment time 20 is 12 seconds and the elapsed time is 3 seconds.

(D) of FIG. 2 illustrates still another display example regarding the key code 25 as a modification example. The key code 25 is displayed in the form of an image of a QR code as a key code 25b on the display screen 300 of (D). This QR code is obtained by coding the key code 25. The payment processing completion confirming information may be provided in the form of the code or the like in this manner. In this case, the purchaser 2 shows a screen including this key code 25b to the clerk 5. The clerk 5 reads this key code 25b by using a QR code reader (or a camera) connected to the store terminal 7, for example. The store terminal 7 obtains the corresponding key code by recognizing the key code 25b, and displays it on the display screen of the clerk 5 side. As a result, the clerk 5 can confirm the completion of the cashless payment from the key code.

Note that, in a case where the cashless payment method according to the first embodiment is applied to an unmanned store, a store terminal having a payment function for self-payment by the purchaser 2 is used as the store terminal 7. In this case, a cashless payment procedure may be a procedure until the payment processing completion confirming information of the display screen 300 in the information terminal 3 as illustrated in (B) of FIG. 2 is confirmed by the purchaser 2. Further, in this case, since there is no confirmation by the clerk 5, the display of the key code 25 on the display screen 300 as illustrated in (B) of FIG. 2 and the corresponding display of the key code at the store terminal 7 side may be omitted. The information terminal 3 and the store terminal 7 store the payment processing completion confirming information received from the server 12 (in particular, the key code) in the memory as the log without displaying it on the display screen. As a result, the purchaser 2 and the clerk 5 can later refer to the key code for confirmation.

Note that at the time of the cashless payment procedure using the application 41, the information terminal 3 may provide predetermined guidance or the like by display or audio as a user interface to the purchaser 2. The guidance includes a situation that messages “please photograph a QR code” and “please photograph an amount” are outputted by display or audio, for example. As one example, the information terminal 3 first outputs the message “please photograph a QR code”, and the user photographs a picture centering the QR code 8 by the camera 30. At that time, the purchase amount 9 in the vicinity of the QR code 8 may be captured in a photographed image. In a case where only the QR code 8 can be recognized from the photographed image, the information terminal 3 then outputs the message “please photograph an amount”, and the user photographs a picture centering the purchase amount 9 by the camera 30. In a case where both the QR code 8 and the purchase amount 9 can be recognized from one image at the same time, it is possible to omit output of the message regarding the amount.

[1-4: Information Terminal]

FIG. 3 illustrates an example of a functional block configuration of the information terminal 3. In the present embodiment, the information terminal 3 is a smartphone. The information terminal 3 includes the camera 30, a group of sensors 31, a graphic processor 32, a touch panel (a display device including the display screen 300) 33, a microphone 34A, a speaker 34B, an external interface 35, a communication unit 36, a CPU 37, a RAM 38, a flash ROM 39, and an internal bus 42. The group of sensors 31 includes an acceleration sensor, a gyro sensor, a geomagnetic a sensor, and a GPS receiver, for example. The CPU 37 constitutes a processor or controller configured to control the entire information terminal 3. Programs such as a basic operation program 40 and the application (the cashless payment application) 41 are stored in the flash ROM 39. The CPU 37, which is the processor, develops these programs on the RAM 38 to execute processes according to the programs, whereby the respective functions of the information terminal 3 are realized. Data generate in the process of execution of program processing and as a result thereof are also stored in the flash ROM 39.

The communication unit 36 has a communication function corresponding to various kinds of communication interfaces such as mobile communication, wireless LAN communication, and short-range communication. As an example of the short-range communication interface, BlueTooth (registered trademark) and the like can be used. Further, the external interface 35 has a USB (registered trademark) interface having a power feeding function, for example. The touch panel 33 is a display device having a touch detecting function, and displays an image drawn by the graphic processor 32 on the display screen 300. The touch panel 33 receives an input operation such as a touch operation against the display screen 300 by the user to detect it by a built-in sensor.

[1-5: Processing Flow]

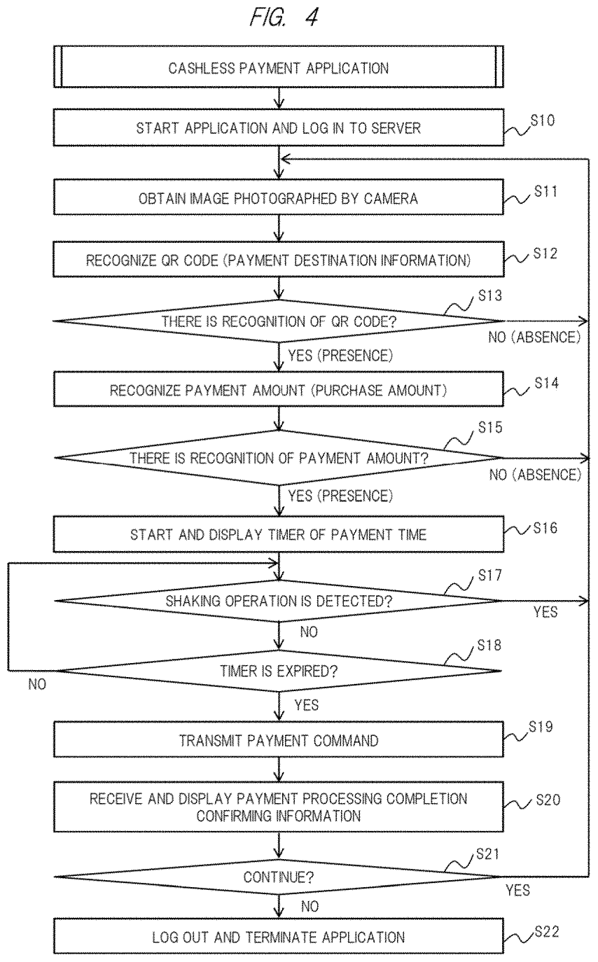

FIG. 4 illustrates a processing flow by the application 41 of the information terminal 3. The flow illustrated in FIG. 4 has Steps S10, S11, . . . , S22. First, at Step S10, the information terminal 3 starts the application 41 on the basis of an operation of the purchaser 2 to log in to the server 12, and starts a cashless payment procedure.

This log-in is log-in for the cashless payment procedure to the server 12, and includes authentication for enhancing security at the time of payment. Note that success of authentication (for example, face authentication or fingerprint authentication) provided in the information terminal 3 itself and start of the application 41 may be regarded as authenticated, that is, a state where it is confirmed that the user is an authorized user, and this log-in may be omitted. Further, as a modification example, a security level may be defined in accordance with a size of the purchase amount 9, and payment rules including necessity of log-in according to the security level may be defined. For example, in a case where a value of a payment amount is equal to or more than a defined threshold value on the basis of preset setting, the log-in at Step S10 is required. In a case where the value is less than the threshold value, the log-in may be omitted.

At Step S11, as described above, the purchaser 2 photographs a QR code 8 and a purchase amount 9 by operating the camera 30. The information terminal 3 executes photograph by the camera 30, in particular, capture of one or more still images on the basis of an operation of the purchaser 2, and obtains photographed image data to memorize them in the RAM 38.

At Step S12, the information terminal 3 scans the photographed image to extract an area of the QR code 8, and decodes the QR code 8 to recognize payment destination information and the like. At Step S13, the processing flow branches in accordance with whether there is recognition of the payment destination information in the QR code 8 or not. In a case where there is recognition of the payment destination information of the QR code 8 (YES), the processing flow proceeds to Step S14. In a case where there is no recognition (NO), the processing flow returns to Step S11 to repeat the steps in the similar manner. The case where there is no recognition (NO) corresponds to a case where the QR code 8 is not included in the photographed image, or a case where information cannot be extracted or recognized even though the QR code 8 is included in the photographed image. A recognition result such as the Payment destination information of the QR code 8 is held in the RAM 38.

At Step S14, the information terminal 3 extracts an area of the purchase amount 9 by scanning the photographed image to recognize a corresponding payment amount. A technique for recognizing characters from an image can be applied to the processing at this time as well as an OCR (optical character recognition) technique. The recognition result of the payment amount is held in the RAM 38. At Step S15, the processing flow branches depending upon presence or absence of recognition of the payment amount. In a case where there is recognition of the payment amount (YES), the processing flow proceeds to Step S16. In a case where there is no recognition of the payment amount (NO), the processing flow returns to Step S11, and repeats the steps in the similar manner.

At Step S16, since it is a state where there are the Payment destination information and the payment amount, which are the two kinds of information described above, the information terminal 3 starts a timer for a payment time 20 as illustrated in (A) of FIG. 2, and displays an image of the payment time 20 in the display screen 300. The payment time 20 can be set to an arbitrary time in advance in the application 41. For example, the payment time 20 is set to 5 seconds by default, and can be adjusted so as to increase or decrease by user setting. In a case where the user wants to determine the payment time 20 more carefully, the user can set a length of the payment time 20 to 10 seconds or the like, for example. In a case where the user wants to pay more quickly, the user can set a length of the payment time 20 to 3 seconds or the like, for example.

At Step S18 after Step S17, the information terminal 3 confirms whether the payment time 20 is expired or not by the above timer. In a case where the payment time 20 is expired (YES), the processing flow proceeds to Step S19. In a case where the payment time 20 is not expired (NO), the processing flow returns to Step S17. At Step S17, the information terminal 3 detects and confirms presence or absence of a predetermined cancellation operation in the middle of the payment time 20. This cancellation operation is an operation of cancelling a cashless payment, more specifically, transmission of a payment command. In the present embodiment, this cancellation operation is defined in advance as a shaking operation so that the purchaser 2 shakes the information terminal 3 held by his or her hand. The information terminal 3 detects the shaking operation by using the group of sensors 31 illustrated in FIG. 3. In a case where the information terminal 3 detects a shaking operation in the middle of the payment time 20 (YES), the information terminal 3 causes the processing flow to return to Step S11, and redo the cashless payment procedure from the photographing, for example.

At Step S19, on the basis of the two kinds of information described above, the information terminal 3 issues a payment command accompanied by information on the purchaser 2 and the information terminal 3, the payment destination information, and the payment amount, and transmits the payment command to the server 12 as the signal 4a illustrated in FIG. 1. At Step S20, the information terminal 3 waits for and receive payment processing completion confirming information from the server 12, and displays a key code 25 and the like illustrated in (B) of FIG. 2, which are the payment processing completion confirming information, in the display screen 300.

The first cashless payment procedure has been completed up to Step S20. Step S21 is confirmation as to whether second and subsequent cashless payment procedures regarding purchase of the other products 6 are repeatedly continued in the similar manner while the application 41 is running. At Step S21, for example, the information terminal 3 may display a message or a button for confirming whether the procedure for the payment is continued or not as a guidance on the display screen 300, and receive an operation by the purchaser 2. In a case where the procedure is to be continued (YES), the processing flow returns to Step S11, and the information terminal 3 repeats steps in the similar manner. In a case where the procedure is to be terminated (NO), the processing flow proceeds to Step S22. At Step S22, the information terminal 3 logs out from the server 12, and causes the application 41 to be terminated.

Note that as a modification example, the procedure may be configured so as to log in to the server 12 at a time point before the payment command at Step S19 is transmitted instead of the configuration in which the login is first executed at Step S10.

[1-6: Effects and the Like]

As described above, according to the first embodiment, while the purchaser 2 is not required for operations such as an input operation and a correction operation regarding the purchase amount 9 of the product 6, and a payment execution operation, the purchaser 2 can suitably carry out the cashless payment with less operation. Further, according to the first embodiment, in case of the user scanning method using the QR code, it is possible for the purchaser 2 to carry out a cashless payment by substantially the same method regardless of the store attribute such as a manned store or an unmanned store.

As a modification example of the first embodiment, the following is also possible. In the modification example, a payment indication operation may be used as a predetermined operation so that a payment command can be immediately transferred without waiting for the elapse of a predetermined payment time 20. For example, after recognizing the two kinds of information described above, the information terminal 3 displays the payment time 20 on the display screen 300 ((A) of FIG. 2, and Step S16 of FIG. 4), and receives not only a cancellation operation but also a payment indication operation in the middle of the payment time 20. As the payment indication operation, an operation of tapping a predetermined site on the display screen 300 of the information terminal 3, an operation of tapping twice in a row, an operation of pressing a predetermined site more strongly than a certain extent, and the like can be cited, for example. In a case where the information terminal 3 detects a payment indication operation, the information terminal 3 terminates the payment time 20 at that time point, and immediately transmits the payment command to the server 12. Such a function is useful for a case where the purchaser 2 wants to pay quickly.

As another modification example, an operation for suspending the elapse of the payment time 20 may be provided as a predetermined operation defined separately from the cancellation operation described above. For example, in a case where the information terminal 3 detects a predetermined suspending operation in the middle of the payment time 20, the information terminal 3 suspends the elapse of the payment time 20. As the suspending operation, an operation of maintaining a touch state against a site in the display screen 300 can be cited, for example. In a case where the information terminal 3 no longer detects the suspending operation, the information terminal 3 restarts the elapse of the payment time 20. This function is useful for a case where the purchaser 2 wavers in his or her determination.

Further, as a still another modification example, the information terminal 3 may determine a length of the payment time 20 in accordance with a size of the purchase amount 9 recognized at Step S14 of FIG. 4 or a type of each corresponding product 6. For example, at the time of a cashless payment procedure of certain times, the information terminal 3 sets a payment time 20 for the certain times so that the larger a value of the recognized purchase amount 9 is, the longer the payment time 20 becomes. For example, in a case where the value of the purchase amount 9 is less than a threshold value, the payment time 20 may be set to 5 seconds. In a case where it is equal to or more than the threshold value, the payment time 20 may be set to 10 seconds. Alternatively, the length of the payment time 20 of the certain times may be calculated by an operation such as multiplication with respect to the value of the recognized payment amount. As a result, for example, the purchaser 2 can determine the length of the payment time 20 carefully as the purchase amount 9 is larger. Further, the information terminal 3 may determine necessity of login thereafter in accordance with the size of the purchase amount 9 recognized at Step S14.

As a still another modification example, the length of the payment time 20 may be defined for each store 1. For example, payment rule information containing not only the payment destination information but also settings regarding the payment time 20 at the store 1 may be described in the QR code 8. The payment rule information may contain the flow provision as illustrated in FIG. 4, for example. The information terminal 3 grasps setting values and the like of the payment time 20 in the payment rule information from the QR code 8, and executes the processes of the procedure in accordance with them. Further, it is not limited to the form in which the payment rule information is directly described in the QR code 8. It may be a form in which payment rule information held in an external device such as the server 12 is referred to from link information, the address information, or the like in the QR code 8.

As a still another modification example, the store attribute such as a manned store or an unmanned store may be described in the QR code 8 as part of the store information. The information terminal 3 grasps a store attribute from recognition of the QR code 8, and controls so as to execute the processes of the procedure in accordance with the store attribute. For example, whether the payment processing completion confirming information described above is displayed or not can be controlled automatically in accordance with whether the store 1 is a manned store or an unmanned store. Further, information on equipment and functions provided in the store 1 may be described in the QR code 8. For example, in a case where the store 1 is a manned store, information on the type, attached equipment (for example, QR code reader, and the like), and functions of the store terminal 7 can be obtained from the QR code 8. The information terminal 3 controls the processes of the procedure in accordance with the obtained information.

### Second Embodiment

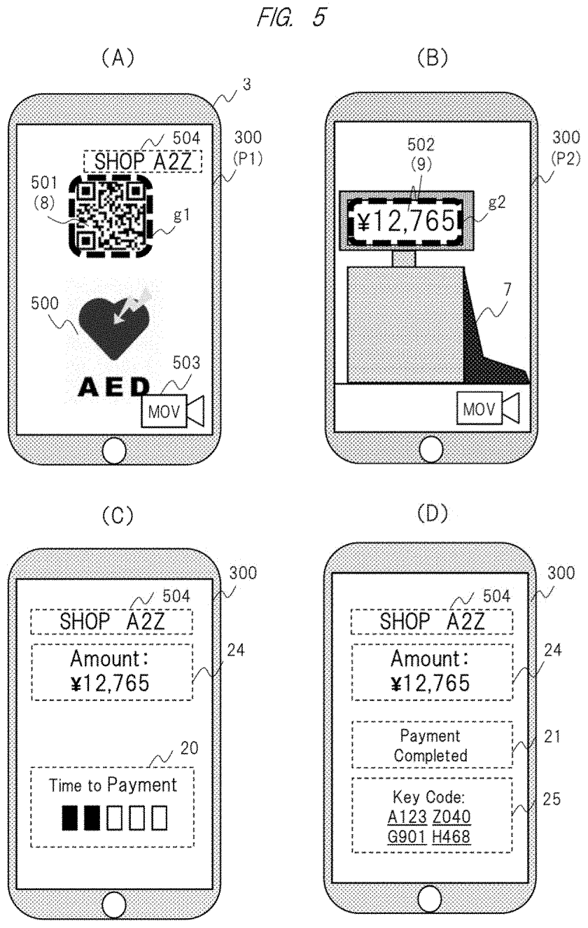

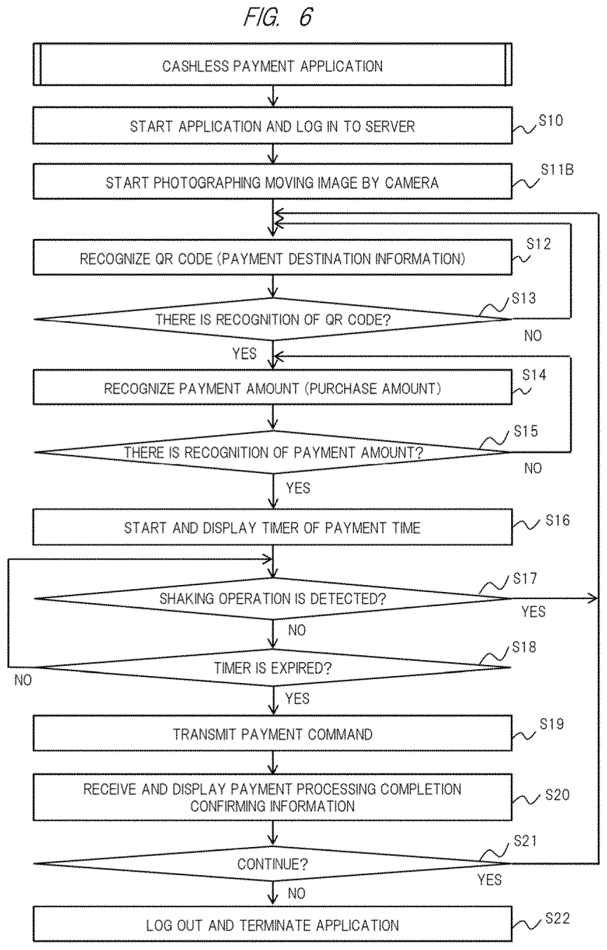

A cashless payment system and the like according to a second embodiment of the present invention will be described with reference to FIG. 5 and FIG. 6. Hereinafter, components of the second embodiment different from those of the first embodiment will be described. In the second embodiment, many parts in the system illustrated in FIG. 1 and the information terminal illustrated in FIG. 3 can be applied commonly.

[2-1: Display Screen]

FIG. 5 illustrates an example of a display screen 300 of an information terminal 3 in the process of a cashless payment according to the second embodiment. In the example of the second embodiment, a method of photographing two elements of a QR code 8 and a purchase amount 9 as a moving image by a camera 30 is used. A purchaser 2 appropriately presses a photographing button of the camera 30 as a minimum operation. The information terminal 3 photographs a moving image or a plurality of continuous still images by using a moving image mode or a continuous time-lapse mode in the camera 30 on the basis of an operation of the purchaser 2. At this time, the QR code 8 and the purchase amount 9 illustrated in FIG. 1 may be captured in a plurality of images constituting the moving image. The QR code 8 and the purchase amount 9 may be captured in the same image at the same time, or may respectively be captured in separate images. For example, in the moving image, the QR code 8 may be captured in a first image earlier in time, and the purchase amount 9 may be captured in a second image later in time. Then, the information terminal 3 recognizes payment destination information and a payment amount, which are the two kinds of information described above, from an image of the moving image.

(A) of FIG. 5 illustrates a state where on the display screen 300 of the information terminal 3, an area 501 corresponding to a QR code 8 is captured from an image of a moving image, particular, a first image by the camera 30, and is recognized. The first image corresponds to an image P1 as a monitor image on the display screen 300. Further, in this example of the display screen 300, a frame image g1 representing that the QR code 8 is recognized is displayed.

In the second embodiment, the QR code 8 may be posted at a place or a position different from that of the store terminal 7 in the store 1. For example, the QR code 8 may be posted at an arbitrary position in the store 1 where the purchaser 2 wants to be interested. For example, the position may be next to a new product or a sales product, or, as illustrated in (A), it may be a position near a position where an AED 500 related to safety of the purchaser 2 is arranged.

Further, an image of a photograph mode 503 is also superimposed and displayed in the display screen 300 illustrated in (A). This is an image that represents the moving image mode or the continuous time-lapse mode as one of the photograph modes of the camera 30. Further, an image of store information 504 (for example, a store name) obtained by recognition of the QR code 8 is also superimposed and displayed in this display screen 300. The image of the store information 504 allows the purchaser 2 to be notified of a payment destination corresponding to this QR code 8.

A display screen 300 illustrated in (B) shows a state where an area 502 corresponding to a purchase amount 9 is captured from the image of the moving image, particularly, a second image by the camera 30, and is recognized. The second image corresponds to an image P2 as a monitor image on the display screen 300. Further, in this example of the display screen 300, a frame image g2 representing that the purchase amount 9 can be recognized is superimposed and displayed.

A display screen 300 illustrated in (C) shows a state where two kinds of information of the QR code 8 illustrated in (A) and the purchase amount 9 illustrated in (B) are recognized, and then, an image of a payment time 20 is displayed on a certain background image. Similar to the first embodiment, immediately after the recognition of the two kinds of information, a timer for the payment time 20 starts counting. Further, in this example of the display screen 300, the image of the store information 504 and an image of a payment amount 24 corresponding to the recognition of the purchase amount 9 are also displayed. The image display of various kinds of information on the display screen 300 may be display by superimposition or composition on an actual photographed image, or may be independent display on a certain background image as illustrated in (C). Similar to the first embodiment, a payment command is issued by expiration of the payment time 20.

A display screen 300 illustrated in (D) shows an example in which payment processing completion confirming information is displayed in accordance with completion of cashless payment processing by a server 12. When the information terminal 3 receives notification of the payment processing completion confirming information from the server 12, the information terminal 3 displays a message 21 and a key code 25 in the display screen 300. In this example of the display screen 300, the message 21 and the key code 25 are displayed on a certain background image. Further, in the present embodiment, the display of the images of the store information 504 and the payment amount 24 are maintained from (C) as it is. As a result, the purchaser 2 can confirm the content and completion of a cashless payment. The purchaser 2 shows this screen to a clerk 5, whereby the clerk 5 can also confirm the completion of the cashless payment.

[2-2: Processing Flow]

FIG. 6 illustrates a processing flow by an application 41 of the information terminal 3 according to the second embodiment. The flow illustrated in FIG. 6 has Step S11B instead of Step S11 as a portion mainly different from the flow illustrated in FIG. 4. At Step S11B, the information terminal 3 sets the camera 30 to the moving image mode to start photographing a moving image. Photographed image data of the moving image is stored in the RAM 38 illustrated in FIG. 3, but is overwritten at regular intervals in consideration of the capacity thereof. At Step S12, the information terminal 3 scans an image of the moving image at that time point to recognize payment destination information from a QR code 8. At Step S13, the information terminal 3 repeats the scanning at Step S12 until the QR code 8 can be recognized (YES). In a case where the QR code 8 is not captured in the image, or in a case where the QR code 8 is captured but cannot be recognized (S13—NO), the processing flow returns to Step S12. A recognition result of the payment destination information is held in the RAM 38.

At Step S14, the information terminal 3 recognizes a payment amount corresponding to a purchase amount 9 from the image at that time point. At Step S15, the information terminal 3 repeats the scanning at Step S14 until the payment amount can be recognized (YES). In a case where the purchase amount 9 is not captured in the image, or in a case where the purchase amount 9 is captured but cannot be recognized (S15—NO), the processing flow returns to Step S14. A recognition result of the payment amount is held in the RAM 38.

At a time point when the two kinds of information of the payment destination information and the payment amount can be recognized, at Step S16, the information terminal 3 displays a payment time 20 on the display screen 300, and causes the timer to start counting. Subsequent steps are similar to those according to the first embodiment.

[2-3: Effects and the Like]

As described above, according to the second embodiment, in addition to the similar effects to those according to the first embodiment, it is possible to simplify the operation of capturing a plurality of still images by photographing a moving image. Further, since it is only necessary to capture the two kinds of information in the moving image, it is also possible to improve the degree of freedom regarding the places or the positions to be posted of the QR code 8 and the purchase amount 9 in the store 1.

The following is also possible as a modification example of the second embodiment. In the modification example, the information terminal 3 is provided with two functions including a mode in which a payment is executed by using a still image as in the first embodiment and a mode in which a payment is executed by using a moving image as in the second embodiment. A user can select and use one mode from them in accordance with settings or the like.

As a modification example, when a moving image is photographed by a camera 30, for example, at least one of a condition that a QR code 8 is recognized as illustrated in (A) of FIG. 5 and a state where an image g1 is displayed is kept for a certain period of time or a condition that a purchase amount 9 is recognized as illustrated in (B) of FIG. 5 and a state where an image g2 is displayed is kept for a certain period of time may be defined as one condition for continuing or executing a cashless payment. For example, in a case where a state where the QR code 8 is recognized can be kept for a certain period of time, the information terminal 3 causes a processing flow to shift to a next procedure of recognizing the purchase amount 9. Further, in a case where a state where the purchase amount 9 is recognized can be kept for a certain period of time, the information terminal 3 causes the processing flow to shift to a procedure of displaying a payment time 20. Further, for example, after the purchase amount 9 is recognized, the information terminal 3 may superimpose and display an image of the payment time 20 on an image in which the purchase amount 9 is captured (for example, substantially the same as (A) of FIG. 2), and keep a state where the purchase amount 9 is captured while waiting for the payment time 20. In a case where a purchaser 2 moves the information terminal 3 in the middle of waiting for the payment time 20 and it becomes a state where the purchase amount 9 is not captured in an image of the camera 30, the information terminal 3 may deal with the state as a cancellation operation.

### Third Embodiment

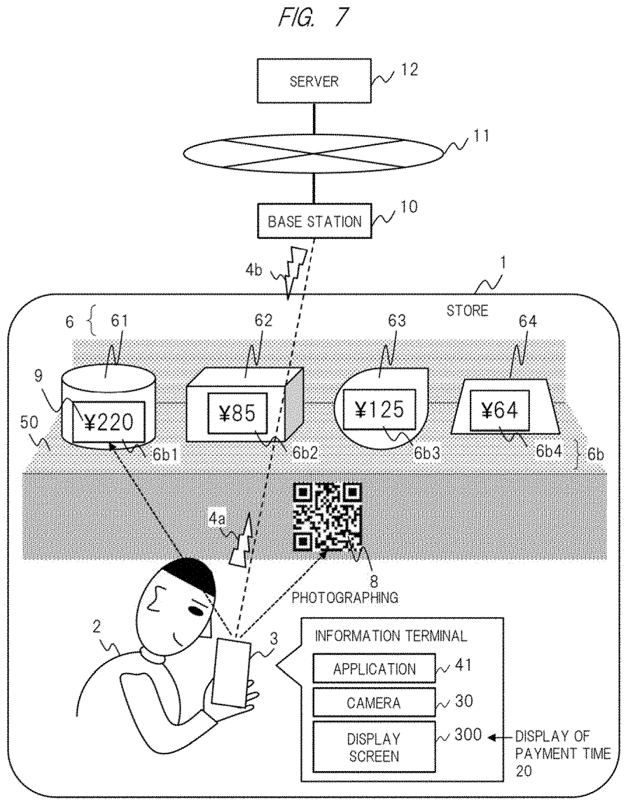

A third embodiment of the present invention will be described with reference to FIG. 7 to FIG. 9. In the third embodiment, the information terminal 3 illustrated in FIG. 3 can be applied commonly. In the third embodiment, a case of payment in an unmanned store or the like is illustrated.

[3-1: Cashless Payment System]

FIG. 7 illustrates a configuration of a cashless payment system according to the third embodiment. In the third embodiment, a store 1 is a small store or an unmanned store such as a product bargain shop, for example, and equipment such as a store terminal 7 is unnecessary and is not provided. In the third embodiment, a purchaser carries out a self-payment in such a store 1. The purchaser 2 reads information on a plurality of desired products 6 in the store 1 by an operation of a camera 30. A total purchase amount 9 resulting from this becomes a payment amount in a first cashless payment.

Products 6 (for example, products 61 to 64) are lined up on a store shelf 50 of the store 1. Price labels 6b (6b1 to 6b4) on each of which information on an amount corresponding to a purchase amount 9 is described are respectively provided on the product 61 to 64 in the form of pasting of a seal. A QR code 8 is posted on a part of the store shelf 50, for example, a part of a front surface thereof facing the purchaser 2 side. A posting position of the QR code 8 is not limited to this.

The purchaser 2 photographs the posted QR code 8 by the camera 30 of the information terminal 3. The information terminal 3 obtains payment destination information from a photographed image by recognizing the QR code 8. Next, the purchaser 2 photographs price labels 6b of one or more products 6 desired to be purchased among the products 6 on the store shelf 50. This photographing may be photograph of a plurality of still images as well as the first embodiment, or photograph of a moving image as well as the second embodiment. In a case where there is a plurality of products 6 to be purchased, the purchaser 2 repeatedly photographs the price label 6b of each product 6 multiple times. In a case where the plurality of price labels 6b can be captured within one image, it may be done. The information terminal 3 scans each of the price labels 6b from the photographed image(s), and recognizes a purchase amount 9 of each product 6. The information terminal 3 calculates a total of one or more purchase amounts 9 thus recognized as a payment amount.

Note that as a modification example, the information terminal 3 may recognize individual product 6 from a photographed image by analyzing color, a shape, and the like, and automatically determine the purchase amount 9 on the basis of the recognized product 6. For example, the information terminal 3 may refer to a product DB provided in the information terminal 3 or a server or the like on a network 11, and obtain information containing the recognized product 6 and an amount thereof.

As described above, after the information terminal 3 recognizes the two kinds of information of the payment destination information of the QR code 8 and the payment amount of the product 6 to be purchased, the information terminal 3 displays a payment time 20 on a display screen 300, and issues a payment command after the payment time 20 is expired.

[3-2: Display Screen]

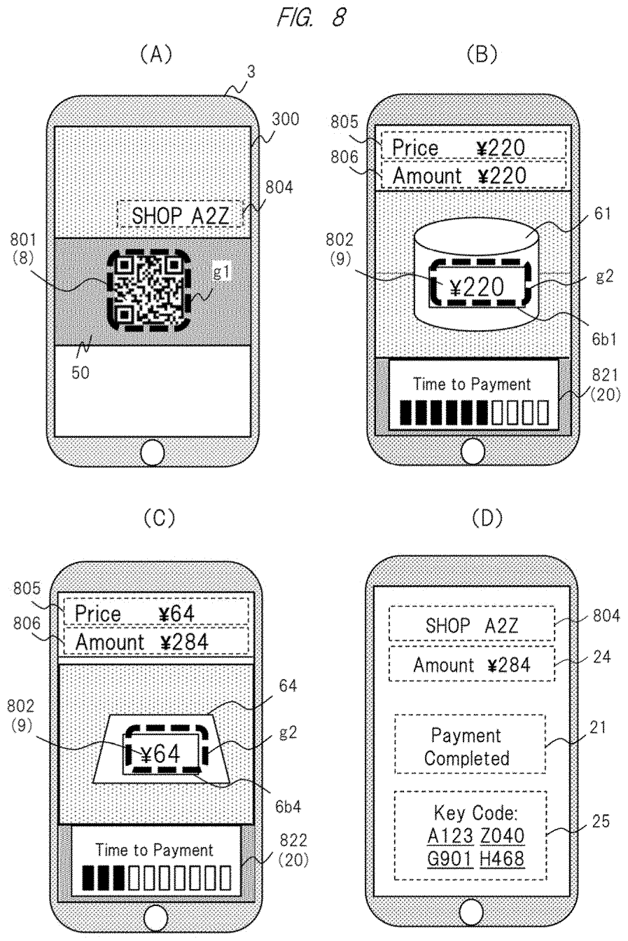

FIG. 8 illustrates an example of the display screen 300 of the information terminal 3 in the process of a cashless payment according to the third embodiment. In the present embodiment, a case of photograph of a plurality of still images is illustrated, but it can similarly be realized even in a case of photograph of a moving image. A display screen 300 illustrated in (A) of FIG. 8 shows a state where the QR code 8 illustrated in FIG. 7 is captured and recognized by the camera 30 of the information terminal 3. On this display screen 300, an area 801 corresponding to the QR code 8 on the store shelf 50 is recognized in a first image photographed at a first time point, and an image g1 representing that the QR code 8 is recognized and an image of store information 804 obtained from the QR code 8 are also displayed.

A display screen 300 illustrated in (B) of FIG. 8 shows a state where a first product, which is a purchase target, the product 61 illustrated in FIG. 7, and the price label 6b1 thereof are captured and recognized by the camera 30 of the information terminal 3, for example. On this display screen 300, an area 802 of the purchase amount 9 indicating the price label 6b1 of the product 61 is recognized in a second image photographed at a second time point, and an image g2 is displayed. Further, on this display screen 300, image information 805 representing the purchase amount 9 (for example, ¥220) of one product 61 recognized from the price label 6b1 and image information 806 on a payment amount (for example, ¥220), which is a total amount of the purchase amount 9 until that time point are superimposed and displayed in an area at an upper side of the display screen 300, for example. Further, for example, an image 821 of the payment time 20 is displayed in an area at a lower side of the display screen 300. This image 821 is an image of the payment time 20 in a case where a cashless payment up to the first product is executed. It will be described later, but in a case where a purchase amount 9 of a next second product is recognized before this payment time 20 is expired, the payment is not executed, and it is update to display as illustrated in (C).

A display screen 300 illustrated in (C) of FIG. 8 shows a state where a second product, for example, the product 64 and the price label 6b4 thereof are recognized by the camera 30 of the information terminal 3. On this display screen 300, image information 805 on a purchase amount 9 (for example, ¥64) of the product 64 and image information 806 on the total payment amount (for example, ¥284) at that time point are superimposed and displayed in a third image photographed at a third time point. Further, on this display screen 300, the display of the payment time 20 is updated in accordance with recognition of the purchase amount 9 of the second product to become an image 822. A count of a timer for the payment time 20 illustrated in (B) is reset in the recognition of the purchase amount 9 of the second product, and a count of a timer for the payment time 20 illustrated in (C) is started. In the present embodiment, the payment time 20 is set to, for example, 10 seconds in consideration of the time allowance for the purchaser 2 to confirm the amount and the like. A payment command is issued automatically at a time point when the payment time 20 is expired.

A display screen 300 illustrated in (D) of FIG. 8 shows a display example at the time of confirming completion of payment processing. On this display screen 300, the store information 804, the image information 806 on the payment amount, a message 21 for confirming the completion of the payment processing, and a key code 25 are displayed on a certain background image. As a result, the purchaser 2 can confirm the content and the completion of the cashless payment. In case of an unmanned store, a cashless payment procedure is now completed. In case of a manned store, the purchaser 2 may show the display screen 300 illustrated in (D) to the clerk 5, and the clerk 5 may confirm it.

[3-3: Processing Flow]

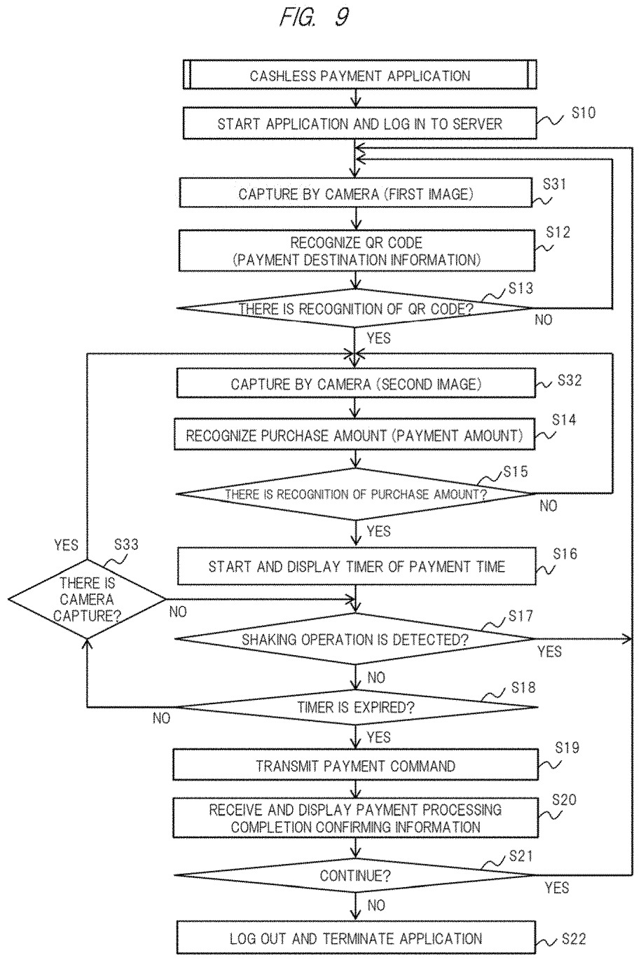

FIG. 9 illustrates a processing flow by an application 41 according to the third embodiment. The flow illustrated in FIG. 9 has Steps S31, S32, and S33 as a portion different from the flow described above. After Step S10, at Step S31, the information terminal 3 captures a first image as photograph by the camera 30, for example. At Step S12, the information terminal 3 recognizes payment destination information, which is the content of a QR code 8, from the first image. In a case where the QR code 8 is recognized (YES), at Step S32, the information terminal 3 captures a second image as photograph by the camera 30. At Step S14, the information terminal 3 recognizes a purchase amount 9 from the second image on the basis of a price label 6b of a product 6. In a case where the purchase amount 9 is recognized (S15—YES), at Step S16, the information terminal 3 calculates and displays a payment amount by a total of the purchase amount(s) 9 of the product(s) 6 until that time point, and displays a payment time 20 to start a timer.

At Step S17, in a case where the information terminal detects a predetermined cancellation operation (for example, a shaking operation) (YES), the processing flow returns to Step S31. At Step S18, the information terminal 3 confirms whether the timer for the payment time 20 is expired or not. In a case where the timer is not expired (NO), at Step S33, the information terminal 3 confirms whether there is a new capturing operation by the camera 30 or not. As described above, this is confirmation that corresponds to a case where the purchaser 2 continuously purchases a next product 6. In a case where there is a capturing operation (YES), the processing flow returns to Step S32. In a case where there is no capturing operation (NO), the processing flow returns to Step S17. In a case where the processing flow returns to Step S32, the information terminal 3 captures a new image (for example, a third image), and repeats the processes after Step S14 in the similar manner. In that case, at the time of update of the display of the payment time 20 at Step S16, a count of the timer is reset. In a case where the timer for the Payment time 20 is expired (YES), at Step S19, the information terminal 3 issues a payment command. Subsequent processes are similar to those described above.

[3-4: Effects and the Like]

As described above, according to the third embodiment, in addition to the effects similar to those according the first and second embodiments, the cashless payment can be made even in case of an unmanned store or the like in the substantially similar manner to that in case of a manned store. In the third embodiment, equipment on the store 1 side does not require equipment of the store terminal 7 such as a cash register, and is therefore suitable for application to the store 1 with a small capital investment.

The following is also possible as a modification example of the third embodiment. First, in FIG. 7, in a case where a tag on which a bar code or the like for product management is described as a price label 6b is provided as a product 6 in a store 1, the following measures can be taken. After the information terminal 3 recognizes payment destination information from a QR code 8 on the basis of an image of the camera 30, the information terminal 3 recognizes the bar code from the price label 6b of the product 6 to be purchased, and obtains information such as a purchase amount. The information terminal 3 displays information such as the purchase amount and a total payment amount on the display screen 300. Then, the information terminal 3 displays a payment time 20, and executes processes in the similar manner to those described above.

In the third embodiment, as illustrated in FIG. 8, the configuration in which the payment time 20 is updated in accordance with recognition of the purchase amount 9 for each product 6 to be purchased has been described. However, it is not limited to this. In another modification example, an information terminal 3 is provided with GUI parts such as a button for calculating a total amount, that is, a payment amount and displaying it in a display screen 300. In other words, this button is a button for instructing transition to payment execution. In a case where a purchaser 2 operates the button or the like, the information terminal 3 displays a payment time 20 on the display screen 300 for the first time, and starts counting a timer. The information terminal 3 issues a payment command after the timer is expired. As still another modification example, after a payment time 20 has elapsed, the information terminal 3 may display a button or the like for issuing a payment command for final confirmation on a display screen 300, and issue the payment command in response to an operation against the button.

### Fourth Embodiment

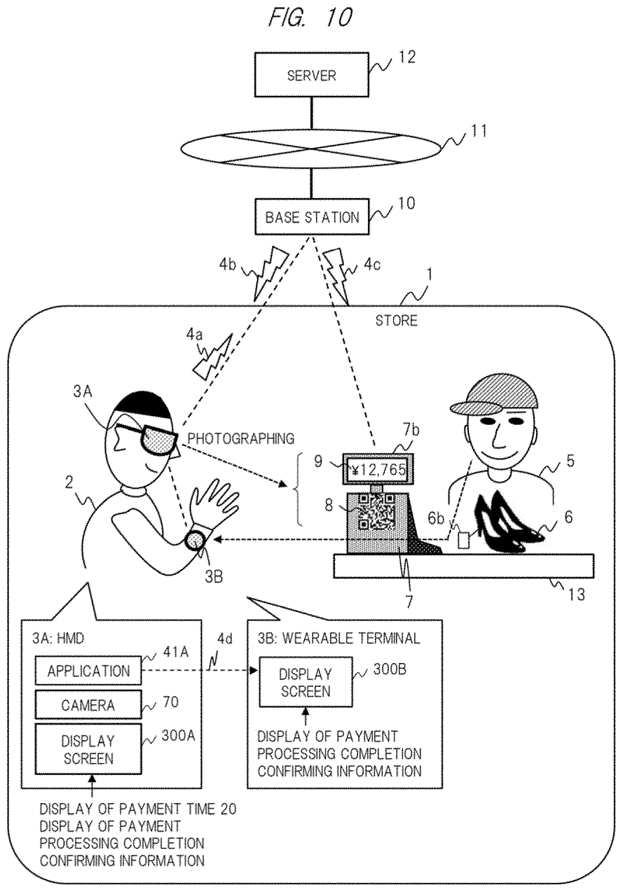

A fourth embodiment of the present invention will be described with reference to FIG. 10. In the fourth embodiment, a case where an HMD (head mounted display) or a wearable terminal is used as an information terminal 3 will be described.

[4-1: Cashless Payment System]

FIG. 10 illustrates a configuration of a cashless payment system according to the fourth embodiment. This cashless payment system has two devices constituting the information terminal 3 (a cashless payment terminal) of a purchaser 2, which includes an HMD 3A as a first information terminal and a wearable terminal 3B as a second information terminal. The HMD 3A is worn on a head of the purchaser 2, and is a device that has a function capable of displaying an image corresponding to augmented reality (AR) or the like on a display screen 300A (for example, a see-through type display surface) corresponding to a field of view of the purchaser 2. The wearable terminal 3B is, for example, a smart watch worn on his or her wrist of the purchaser 2, and has a display function capable of displaying an image on a display screen 300B. The wearable terminal 3B can show payment processing completion confirming information described above to a clerk 5 by using the display function.

The HMD 3A and the wearable terminal 3B are connected to each other by low power communication or short-range communication using a communication interface such as BlueTooth (registered trademark), for example, and both of them function in cooperation with each other. The HMD 3A includes an application (a cashless payment application) 41A, a camera 70, and the like. The wearable terminal 3B may include an application that cooperates with the application 41A. The wearable terminal 3B may be a device having the display function, and may be a smartphone or the like

At the time of a cashless payment, the purchaser 2 photographs a QR code 8 and a purchase amount 9 by the camera 70 of the HMD 3A. The HMD 3A obtains payment destination information from a photographed image of the camera 70 by recognition of the QR code 8, and obtains a payment amount by recognition of the purchase amount 9. When the HMD 3A recognizes two kinds of information, the HMD 3A displays a payment time 20 on the display screen 300A, and transmits a payment command to the server 12 in response to expiration of the payment time 20 (a signal 4a). The server 12 executes cashless payment processing by using information on the purchaser 2 and the information terminal (the HMD 3A), the payment destination information, and payment amount information in the received payment command. The server 12 transmits payment processing completion confirming information to the HMD 3A (a signal 4b). The server 12 may transmit payment processing completion confirming information associated with that of the information terminal 3 side to the store terminal 7 (a signal 4c).

The HMD 3A transfers information such as a key code to the wearable terminal 3B as a signal 4d on the basis of the payment processing completion confirming information received from the server 12. The wearable terminal 3B displays the information on the key code on the display screen 300B. The purchaser 2 shows he information on the key code displayed on the display screen 300B of the wearable terminal 3B to the clerk 5. This makes it possible for the purchaser 2 and the clerk 5 to confirm completion of the cashless payment processing.

[4-2: Display Screen]

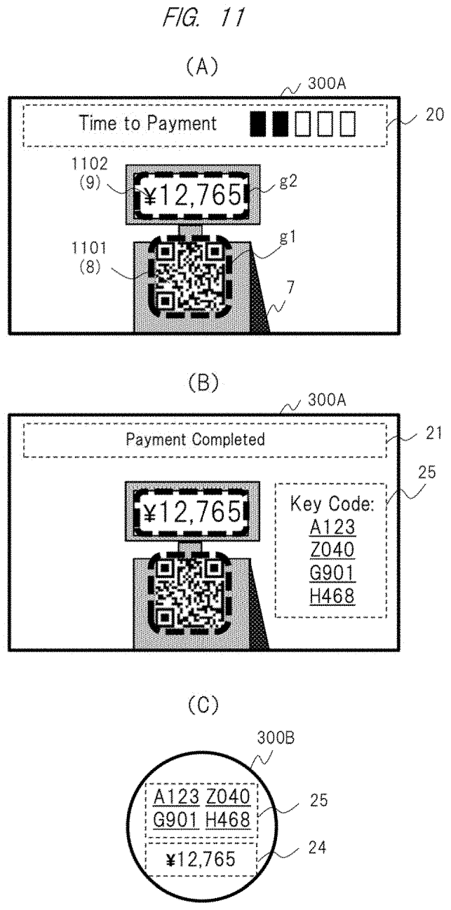

FIG. 11 illustrates an example of the display screen of the HMD 3A and the wearable terminal 3B in the process of the cashless payment according to the fourth embodiment. (A) of FIG. 11 illustrates an example of the display screen 300A in the HMD 3A. On this display screen 300A, an area 1101 for the QR code 8 is recognized from the photographed image of the camera 70, and an image g1 such as a frame is displayed. Further, an area 1102 for the purchase amount is recognized, and an image g2 such as a frame is displayed. Moreover, on this display screen 300A, an image of the payment time 20 is superimposed and displayed at an upper area, for example, in accordance with recognition of these two kinds of information. When the payment time 20 is expired, the HMD 3A issues the payment command, and transmits it to the server 12.

(B) of FIG. 11 illustrates an example of the display screen 300A in which the payment processing completion confirming information is displayed in the HMD 3A. On this display screen 300A, a message 21 and a key code 25 are superimposed and displayed on the basis of the payment processing completion confirming information received from the server 12. As a result, the purchaser 2 can confirm completion of the cashless payment processing. The HMD 3A transfers information containing the key code and the payment amount of the payment processing completion confirming information to the wearable terminal 3B (the signal 4d).

(C) of FIG. 11 illustrates an example of the display screen 300B in the wearable terminal 3B. The wearable terminal 3B displays the key code 25 and a payment amount on the display screen 300B on the basis of the information received from the HMD 3A. The purchaser 2 shows this display screen 300B to the clerk 5. As a result, the clerk 5 can also confirm the completion of the cashless payment processing. In a case where the key code and the like of the payment processing completion confirming information from the server 12 are displayed on a display device of the store terminal 7 on the clerk 5 side, the clerk 5 can confirm the key code by comparing it with the key code 25 on the display screen 300B at the purchaser 2 side. Note that in a case where the fourth embodiment is to be applied to an unmanned store, the procedure of showing the display screen 300B of the wearable terminal 3B to the clerk 5 at the store 1 side is omitted.

[4-3: HMD]

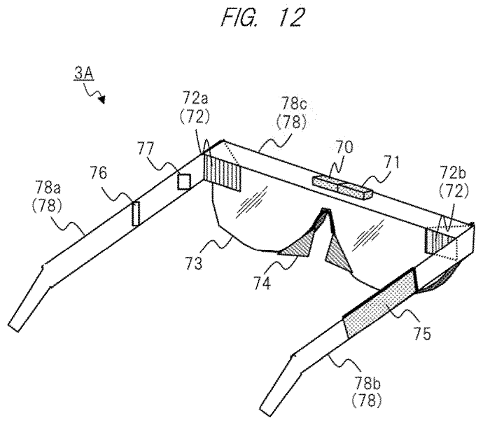

FIG. 12 illustrates an example of an appearance configuration of the HMD 3A. The HMD 3A includes the camera 70, a distance measuring device 71, a projection optical system 72 (72a, 72b), a display optical system 73 such as a lens or a screen, a nose pad 74, a controller 75, a speaker 76, a microphone 77, a frame housing 78 (78a, 78b, 78c), and the like.

The controller 75, the camera 70, the distance measuring device 71, the speaker 76, and the microphone 77 are arranged on the frame housing 78 (78a, 78b, 78c). The arrangement does not have to be as illustrated in FIG. 12. A user wears the HMD 3A on his or her face by means of the frame housing 78 and the nose pad 74.

The camera 70 is attached so as to photograph the front of a line of sight of the user. The distance measuring device 71 measures a distance to a real object in a real space captured as the photographed image of the camera 70. The distance measuring device 71 may calculate the distance to a feature point such as a contour of the real object by a method like a stereo camera, or may irradiate a light beam two-dimensionally like a TOF (Time Of Flight) method to measure the distance. The distance measuring device 71 may be any device that can measure a distance between the HMD 3A and the photographed real object.

A display unit (the display screen 300A) of the HMD 3A is composed of the projection optical system 72 and the display optical system 73. The projection optical system 72 (72a, 72b) projects a screen (a corresponding virtual image) of a virtual object created by computer graphics onto the display optical system 73 as an image confirmed by the left eye and an image confirmed by the right eye, and displays the screen. The purchaser 2 can view a landscape and a real object in front of him or her through the display optical system 73, and the screen of the virtual object projected from the projection optical system 72 can be displayed, via the display optical system 73, at an arbitrary position where it is possible to be easily distinguished from the real object in the real space. The HMD 3A may display the screen of the virtual object at a selected position by using information on the distance measured by the distance measuring device 71. Note that the configuration may be so that the distance measuring device 71 is not provided. In this case, the screen of the virtual object is displayed at a preset position in the real space.

The controller 75 takes in the image of the real space photographed by the camera 70 and data on the positions in the real space of the real object and the like obtained by the distance measuring device 71, and supplies to a memory and a CPU therein. Moreover, the controller 75 creates an image to be projected by the projection optical system 72 and sounds to be outputted to the speaker 76.

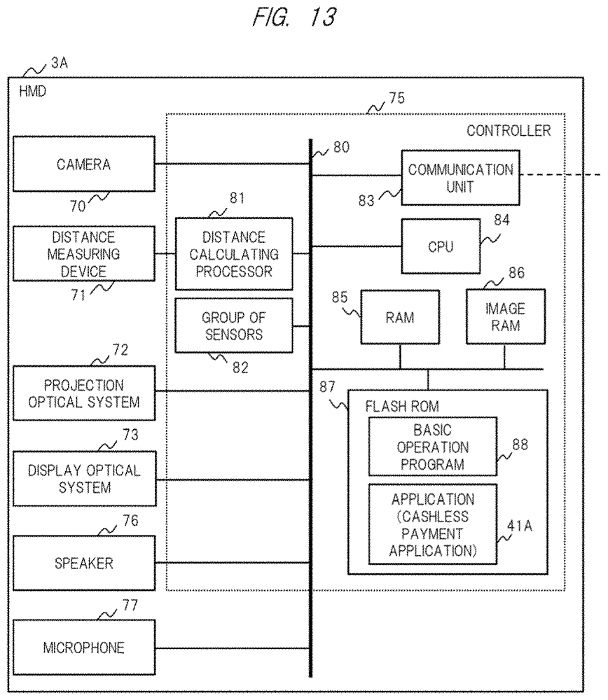

FIG. 13 illustrates an example of a functional block configuration of the HMD 3A. The controller 75 of the HMD 3A includes a communication unit 83, a CPU 84, a RAM 85, an image RAM 86, a flash ROM 87, a distance calculating processor 81, a group of sensors 82, and the like, and these are connected to an internal bus 80. Further, the camera 70, the distance measuring device 71, the projection optical system 72, the display optical system 73, the speaker 76, the microphone 77, and the like are connected to the internal bus 80. The HMD 3A includes a built-in group of sensors 82 including a gyro sensor, an acceleration sensor, a geomagnetic sensor, a position sensor (a GPS receiver), a line-of-sight detecting sensor, and the like. The controller 75 executes a control while using detection information of the group of sensors 82.

The projection optical system 72 causes the display optical system 73 to independently project an image for the left eye by the projection optical system 72a provided at the left side and an image for the right eye by the projection optical system 72b provided at the right side. Alternatively, the projection optical system 72 may be one that projects an image for the left eve and an image for the right eye interleaved by one projector and causes the image for the left eye and the image for the right eye to respectively pass therethrough by a shutter optical system. Moreover, the projection optical system 72 may be an optical system using a holographic lens.

The communication unit 83 has a plurality of communication functions compliant to a plurality of communication interfaces such as mobile communication, a wireless LAN, and short-range communication. For the short-range communication, BlueTooth (registered trademark) or the like can be applied, for example. The communication unit 83 connects the HMD 3A to the network 11 via the base station 10 as illustrated in FIG. 1. Further, the communication unit 83 executes one-to-one communication with the wearable terminal 3B by BlueTooth communication or the like.

A basic operation program 88 and an application (a cashless payment application) 41A are included in the flash ROM 87 as processing programs to be stored. These programs are developed on the RAM 85 by the CPU 84 and the CPU 84 executes processes in accordance with the programs, whereby the respective functions of the HMD 3A are realized. Further, data generated in the process of and as a result of program processing can be stored in the flash ROM 87. Further, image data to be sent out to the projection optical system 72 are stored in the image RAM 86, and are read out from the image RAM 86.

[4-4: Processing Flow]

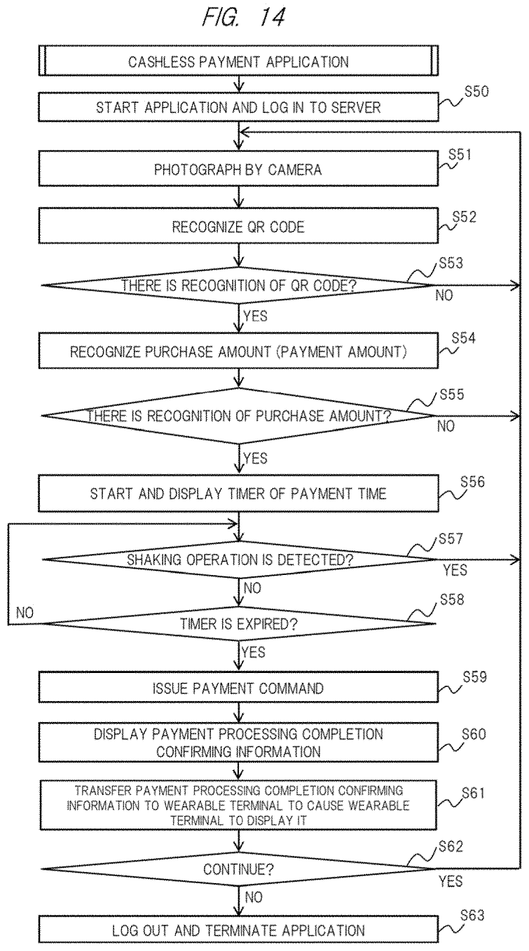

FIG. 14 illustrates a processing flow by an application 41A according to the fourth embodiment. At Step S50, the HMD 3A starts an application 41A to log in to the server 12. At Step S51, the HMD 3A executes photographing by the camera 70 (note that it may be a still image or moving image), and captures a photographed image in the RAM 85. At Step S52, the HMD 3A scans the photographed image to recognize a QR code 8, and obtains payment destination information. In a case where a QR code 8 cannot be recognized (S53—NO), the processing flow returns to Step S51. In a case where a QR code 8 can be recognized (S53—YES), at Step S54, the HMD 3A scans the photographed image to recognize a payment amount corresponding to a purchase amount 9. In a case where a purchase amount cannot be recognized (S55—NO), the processing flow returns to Step S51.

At Step S56, the HMD 3A displays a payment time 20 on the display screen 300A to start a timer. At Step S57, in a case where the HMD 3A detects a cancellation operation in the middle of the payment time 20 (YES), the processing flow returns to Step S51. In the fourth embodiment, this cancellation operation is a shaking operation of shaking his or her head (the corresponding HMD 3A) by the purchaser 2, for example. The shaking operation is set in advance as the cancellation operation in the application 41A. The HMD 3A can detects a shaking operation by the group of sensors 82.

In a case where the timer for the payment time 20 expires at Step S58 (YES), at Step S59, the HMD 3A issues a payment command, and transmits it to the server 12. At Step S60, when the HMD 3A receives payment processing completion confirming information from the server 12, as illustrated in (B) of FIG. 11, the HMD 3A displays the payment processing completion confirming information on the display screen 300A. At Step S61, the HMD 3A transfers, to the wearable terminal 3B, information containing a key code and the payment amount in the payment processing completion confirming information. The wearable terminal 3B displays the key code and the payment amount in the payment processing completion confirming information on the display screen 300B on the basis of the information received from the HMD 3A. In a case where the procedure is to be continued at Step S62 (YES), the processing flow returns to Step S51. In a case where the procedure is to be terminated at Step S62 (NO), at Step S63, the HMD 3A logs out from the server 12, and causes the application 41A to be terminated.

[4-5: Effects and the Like]

As described above, according to the fourth embodiment, in addition to the effects similar to those according to the first embodiment and the like, the purchaser 2 can carry out the cashless payment associated with the purchase of the product 6 by hands free by using the two devices as illustrated in FIG. 10.

### Fifth Embodiment

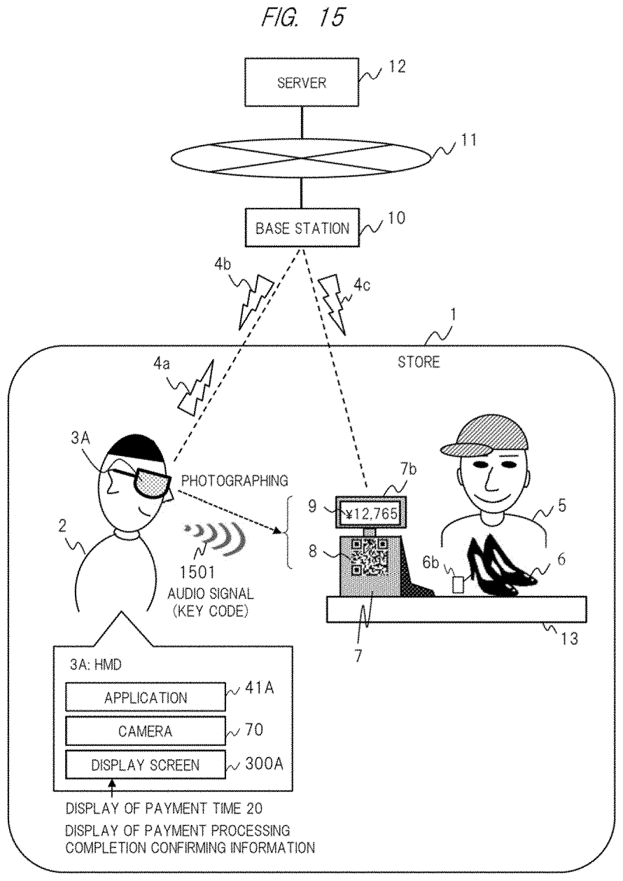

A fifth embodiment of the present invention will be described with reference to FIG. 15. In the fifth embodiment, a case where an audio signal is used is illustrated.

[5-1: Cashless Payment System]

FIG. 15 illustrates a configuration of a cashless payment system according to the fifth embodiment. The configuration illustrated in FIG. 15 is mainly different from the configuration illustrated in FIG. 10 in that a purchaser 2 wears an HMD 3A, but does not wear a wearable terminal 3B. In addition, there is a difference in that the purchaser 2 (or the HMD 3A) transmits payment processing completion confirming information (for example, a key code) to a clerk 5 by an audio signal 1501.

[5-2: Display Screen]

An example of a display screen 300A in the HMD 3A in the process of a cashless payment according to the fifth embodiment is similar to that illustrated in (A) and (B) of FIG. 11 described above. In the fifth embodiment, the purchaser 2 transmits, to the clerk 5, a key code 25 (for example, see (B) of FIG. 11) in payment processing completion confirming information, which is obtained from the server 12 by the HMD 3A and displayed on the display screen 300A, as the audio signal 1501 by producing a sound by the purchaser 2.

In the present embodiment, as illustrated in (B) of FIG. 11, the key code 25 is composed of a plurality (for example, four) of alphanumeric strings. The purchaser 2 selects arbitrary one from the plurality of alphanumeric strings of the key code 25, or selects an alphanumeric string at a portion defined in advance (for example, the lowest four digits), and transmits the selected alphanumeric string to the clerk 5 by the audio signal 1501. The clerk 5 confirms completion of the cashless payment on the basis of the alphanumeric string transmitted by the audio signal 1501 and the key code 25 in the payment processing completion confirming information displayed on a display device of a store terminal 7 at the clerk 5 side.

[5-3: Processing Flow]

A processing flow by an application 41A of the HMD 3A according to the fifth embodiment is substantially similar to the flow according to the first embodiment illustrated in FIG. 4 or the flow according to the fourth embodiment illustrated in FIG. 14. However, there is the following as a different point. Instead of Step S61, after Step S60 in the flow illustrated in FIG. 14, the purchaser 2 transmits, to the clerk 5, the key code 25 (for example, (B) of FIG. 11) in the payment processing completion confirming information, which is displayed on the display screen 300A of the HMD 3A, by the audio signal 1501.

[5-4: Effects and the Like]

As described above, according to the fifth embodiment, the purchaser 2 can carry out a cashless payment associated with purchase of a product by means of the HMD 3A by hands free without needing the wearable terminal 3B, and can carry out the cashless payment by substantially the same method regardless of a store attribute.

The following is also possible as a modification example of the fifth embodiment. In a case where the HMD 3A has an audio synthesis and audio output function, the HMD 3A may use the function to convert the key code 25 in the payment processing completion confirming information into the audio signal 1501 and output it. In this case, the utterance of the purchaser 2 can be omitted.

### Sixth Embodiment

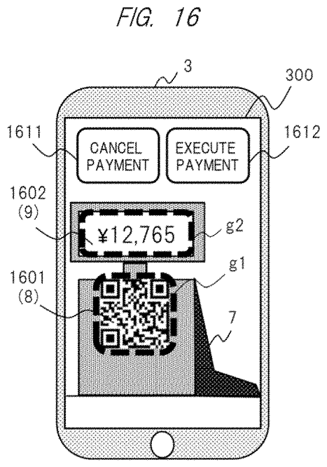

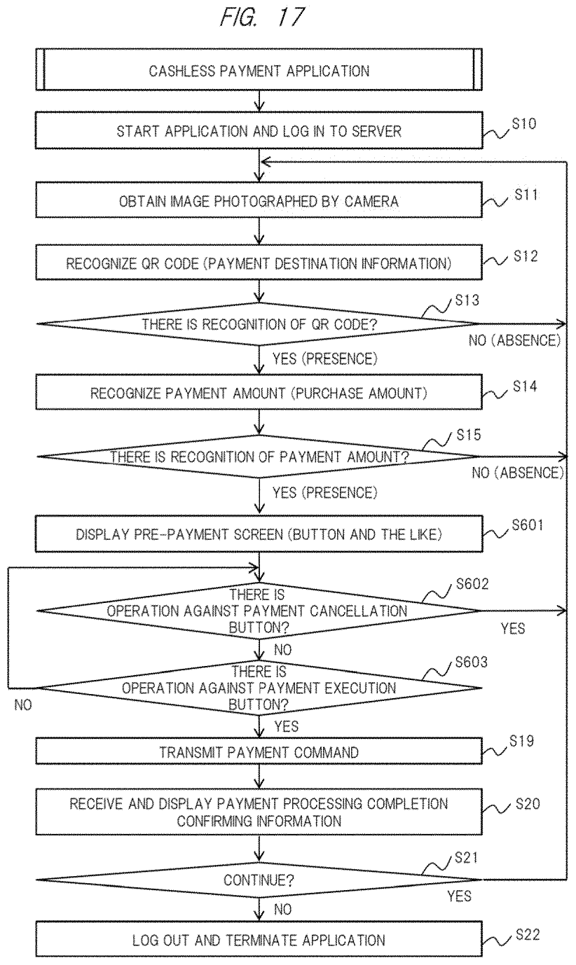

A sixth embodiment of the present invention will be described with reference to FIG. 16 and FIG. 17. In the sixth embodiment, the system illustrated in FIG. 1 and the information terminal 3 illustrated in FIG. 3 can generally be applied commonly.

[6-1: Display Screen]

FIG. 16 illustrates an example of a display screen 300 of an information terminal 3 in the process of a cashless payment according to the sixth embodiment. At the time of capture, a camera 30 of the information terminal 3 captures a store terminal 7 as illustrated in FIG. 1, and displays it on the display screen 300. On the display screen 300 illustrated in FIG. 16, an area 1601 for a QR code 8 and an area 1602 for a purchase amount 9 are recognized from a photographed image, and images g1 and g2 such as frames are also displayed. Moreover, the information terminal 3 displays a payment cancellation button 1611 and a payment execution button 1612 on this display screen 300 as GUI parts, and prompts a purchaser 2 to operate the information terminal 3. In a case where the information terminal 3 receives an operation of pressing the payment cancellation button 1611 by the purchaser 2, the information terminal 3 controls so as to cancel a procedure of payment. In a case where the information terminal 3 receives an operation of pressing the payment execution button 1612 by the purchaser 2, the information terminal 3 issues a payment command, and transmits it to a server 12. An example of the display screen 300 in which payment processing completion confirming information is displayed by the information terminal 3 after the server 12 completes payment processing is similar to that illustrated in (B) of FIG. 2 described above. As described above, in the sixth embodiment, after recognizing two kinds of information, the information terminal 3 omits display of a payment time 20 described above, and displays the payment execution button 1612 and the like.

[6-2: Flow]

FIG. 17 illustrates a processing flow by an application 41 of the information terminal 3 according to the sixth embodiment. The flow illustrated in FIG. 17 is different from the flow according to the first embodiment illustrated in FIG. 4 in that Steps S601 to 5603 are provided instead of Steps S16 to S18 described above. After two of a QR code 8 and a purchase amount 9 are recognized (S15—YES), at Step S601, the information terminal 3 displays a pre-payment screen like the display screen 300 illustrated in FIG. 16. In a case where there is an operation against the payment cancellation button 1611 on the pre-payment screen at Step S602 (YES), the information terminal 3 causes the processing flow to return to Step S11. In a case where there is an operation against the payment execution button 1612 at Step S603 (YES), the information terminal 3 causes the processing flow to proceed to Step S19. In a case where there is no operation against the payment execution button 1612 at Step S603 (NO), the information terminal 3 causes the processing flow to return to Step S602. At Step S19, the information terminal 3 issues a payment command.

[6-3: Effects and the Like]

As described above, according to the sixth embodiment, by carrying out an input operation for the payment execution button 1612 or the like by the purchaser 2 instead of waiting for the payment time 20, it is possible to obtain the similar effects to those according to the first embodiment. Note that as a modification example of the sixth embodiment, the payment time 20 may be displayed on the display screen 300 of the information terminal 3 as in the first embodiment, and the payment execution button 1612 and the like may be displayed as illustrated in FIG. 16. In this case, in a case where the purchaser 2 operates any button in the middle of the payment time 20, it is possible to cancel or execute payment, and it is possible to execute the payment automatically when the payment time 20 is expired.

### Seventh Embodiment

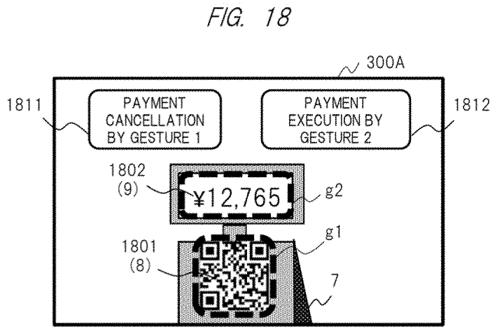

A seventh embodiment of the present invention will be described with reference to FIG. 18. In the seventh embodiment, an HMD is used in the similar manner to that in the fourth embodiment illustrated in FIG. 10 and the fifth embodiment illustrated in FIG. 15.

[7-1: Display Screen]

FIG. 18 illustrates an example of a display screen 300A of an HMD 3A in the process of cashless payment according to the seventh embodiment. On the display screen 300A illustrated in FIG. 18, an area 1801 for a QR code 8 and an area 1802 for a purchase amount 9 are recognized from an image photographed by a camera 70, and images g1 and g2 such as frames are also displayed. Moreover, the HMD 3A displays a “payment cancellation by gesture 1” button 1811 and a “payment execution by gesture 2” button 1812 on the display screen 300A as GUI parts, and prompts the purchaser 2 to operate the HMD 3A. Predetermined gestures, which can be detected by the camera 70 or a group of sensors 82 (FIG. 13) of the HMD 3A, are defined in advance. For example, a first gesture (“gesture 1”) is a motion in which a user places his or her finger in front of the display screen 300A of the HMD 3A and moves the finger in a left direction, and a second gesture (“gesture 2”) is a motion in which the user moves the finger in a right direction. Details of these gestures are not limited thereto, and each of these gestures may be a gesture that can be distinguished and detected by using the camera 70 or the like.

The purchaser 2 looks at the display screen 300A, and carries out an operation related to payment by a predetermined gesture. In a case where the payment is to be cancelled, the purchaser 2 carries out the “gesture 1”. In a case where the payment is to be executed, the purchaser 2 carries out the “gesture 2”. In a case where the HMD 3A recognizes the “gesture 1” by the purchaser 2, the HMD 3A updates a display state so as to prompt the purchaser 2 to press the “payment cancellation by gesture 1” button 1811, and cancels the payment in response to the press. In a case where the HMD 3A recognizes the “gesture 2”, the HMD 3A updates a display state so as to prompt the purchaser 2 to press the “payment execution by gesture 2” button 1812, and issues a payment command in response to the press. The display screen 300A at the time of confirmation of payment completion is similar to that illustrated in (B) of FIG. 11 for example.

As a modification example, it is assumed that the HMD 3A is provided with a line-of-sight sensor. In a case where a line of sight of the purchaser 2 is detected by the line-of-sight sensor and a line-of-sight operation defined in advance is detected, the HMD 3A may control so as to associate the line-of-sight operation to payment cancellation or payment execution as described above. As the line-of-sight operation, an operation in which the line of sight is directed to the left, and an operation in which the line of sight is directed to the right can be cited, for example. Alternatively, another line-of-sight operation may be an operation of gazing at the “payment cancellation by gesture 1” button 1811 or the like.

[7-2: Flow]

A processing flow by an application 41A of the HMD 3A according to the seventh embodiment is substantially similar to the flow illustrated in FIG. 17 according to the sixth embodiment. However, difference points are that Steps S601 to S603 are steps as follows. At Step S601, the HMD 3A displays a pre-payment screen like the display screen 300A illustrated in FIG. 18. In a case where the HMD 3A detects a “gesture 1” corresponding to the “payment cancellation by gesture 1” button 1811 at Step S602 (YES), the processing flow returns to Step S11. In a case where the HMD 3A detects a “gesture 2” corresponding to the “payment execution by gesture 2” button 1812 at Step S603 (YES), the processing flow proceeds to Step S19. In a case where the HMD 3A does not detect the “gesture 2” corresponding to the “payment execution by gesture 2” button 1812 at Step S603 (NO), the processing flow returns to Step S602.

[7-3: Effects and the Like]

As described above, according to the seventh embodiment, it is possible to obtain the similar effects to those according to the sixth embodiment by using the gestures in the HMD.

### Eighth Embodiment

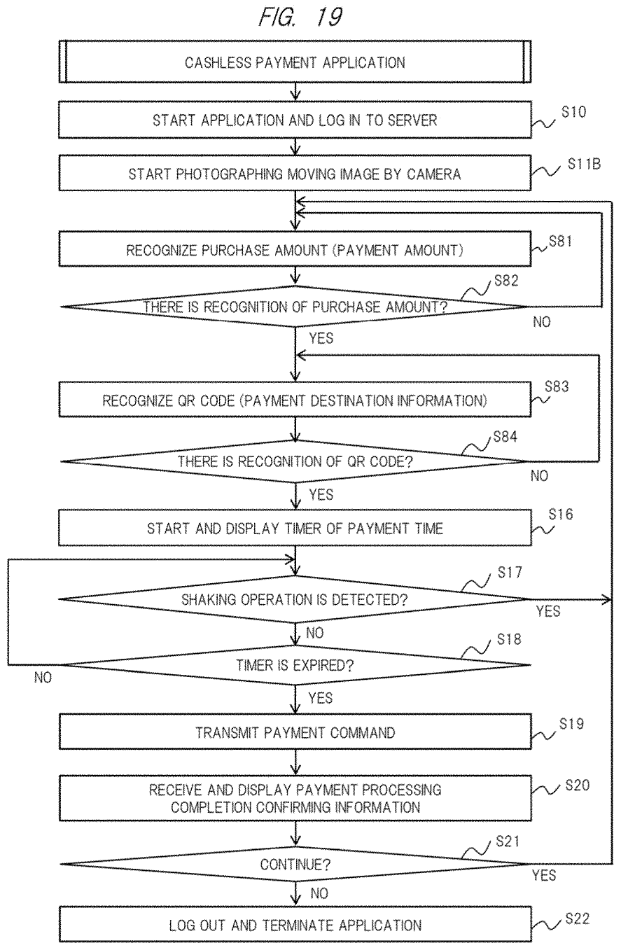

A cashless payment system and the like according to an eighth embodiment of the present invention will be described with reference to FIG. 19. In the first embodiment and the like, the method of first recognizing payment destination information of a QR code and then recognizing a payment amount as a temporal order has been described. On the other hand, in the eighth embodiment, a method of first recognizing a payment amount and then recognizing payment destination information of a QR code as a temporal order will be described. Even in the eighth embodiment, the environment as illustrated in FIG. 1 according to the first embodiment can be applied similarly.

[8-1: Processing Flow]

FIG. 19 illustrates a processing flow by an application 41 of an information terminal 3 according to the eighth embodiment. In the present embodiment, a case where a moving image is used as an image photographed by a camera 30 is described, but a case where a plurality of still images is used is also possible. The flow illustrated in FIG. 19 is different from the flow according to the second embodiment illustrated in FIG. 6 in that Steps S81 to S84 are provided instead of Steps S12 to S15, and as illustrated in FIG. 19, the order of recognition of two kinds of information is reversed. At Step S11B, the information terminal 3 starts photographing a moving image by the camera 30. At Step S81, the information terminal 3 recognizes a payment amount corresponding to a purchase amount 9 by scanning of a first image of the moving image. In a case where there is recognition of the purchase amount 9 (YES), at Step S82, the information terminal 3 recognizes payment destination information of a QR code 8 by scanning of a second image of the moving image. Note that the second image may be the same as the first image. Namely, the similar determination is also established in a case where both the purchase amount 9 and the QR code 8 can be recognized from one image. After recognizing the two kinds of information described above (S84—YES), the information terminal 3 executes the processes after Step S16 in the similar manner to that of the embodiments described above.

[8-2: Effects and the Like]

As described above, in the eighth embodiment, the similar effects to those according to the first embodiment can also be obtained. In case of the eighth embodiment, if one QR code 8 is recognized after recognizing one or more purchase amounts 9, it is possible to transition to display of the payment time 20.

[8-3: Modification Example]

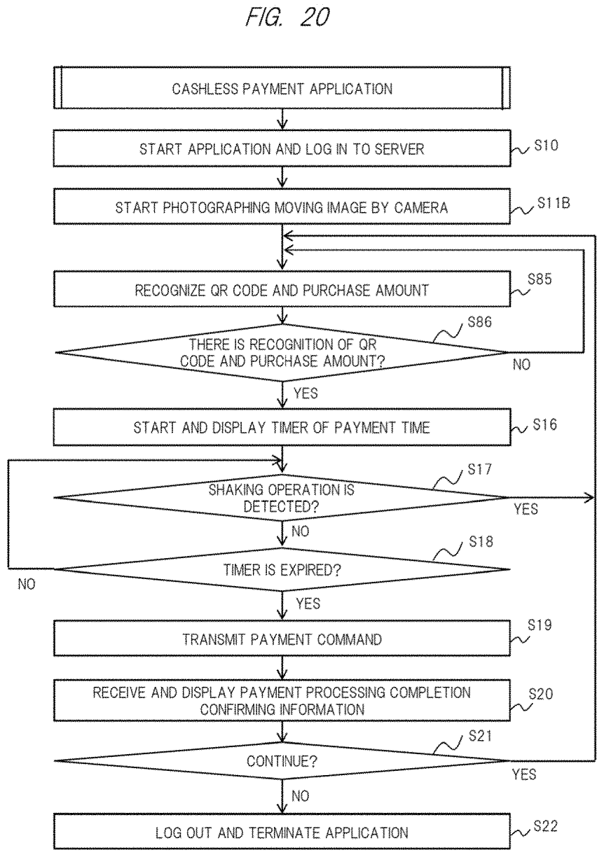

FIG. 20 illustrates a processing flow of an information terminal 3 according to a modification example regarding the first embodiment or the eighth embodiment. This modification example can be regarded as an embodiment obtained by merging the first embodiment and the eighth embodiment into one. Namely, this modification example describes a configuration in which when two kinds of information containing a QR code 8 and one or more purchase amounts 9 are recognized from an image photographed by a camera as illustrated in FIG. 1, the order of recognition of them may be any order, and they can be handled in any order.

The flow illustrated in FIG. 20 has Steps S85 and S86 as different points from the configuration of the flow described above. At Step S11B, the information terminal 3 starts photographing a moving image by a camera 30. At Step S85, the information terminal 3 recognizes two kinds of information of a QR code 8 and a purchase amount 9 in an arbitrary order by scanning an arbitrary image of the moving image. At Step S86, the information terminal 3 confirms whether the information on the both can be recognized or not. The processing flow returns to Step S85 to repeat the processes (S86—NO) until the information on the both can be recognized. After recognizing the two kinds of information (S86—YES), the processes after Step S16 are executed in the similar manner to those described above.

### Nineth Embodiment

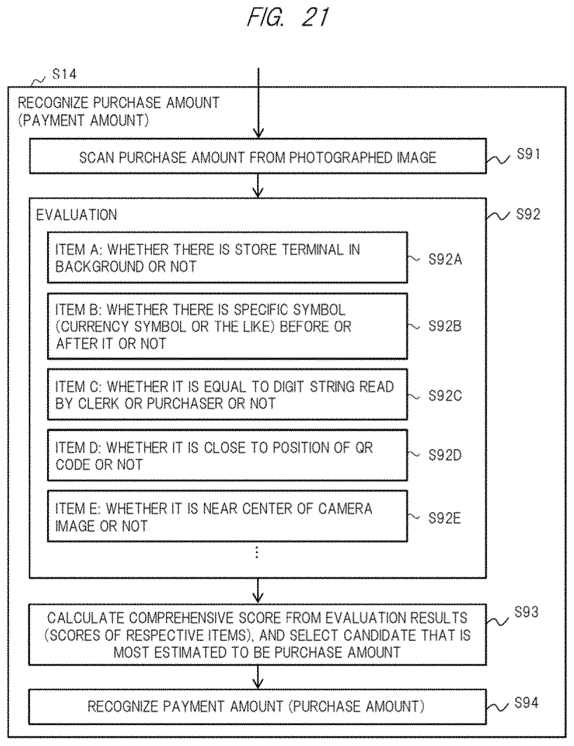

A nineth embodiment of the present invention will be described with reference to FIG. 21 to FIG. 23. The nineth embodiment is a modification example of the first embodiment and the like, and illustrates a detailed configuration example regarding recognition processing of a purchase amount.

[9-1: Processing Flow]

FIG. 21 illustrates an example of a processing flow by an application 41 of an information terminal 3 according to the nineth embodiment. In particular, this flow illustrates a detailed configuration example regarding recognition processing of a purchase amount at Step S14 in the flow illustrated in FIG. 4 according to the first embodiment. This configuration example can also be applied to the similar step in the flow according to each of the embodiments. This configuration example is useful for a case where a character string other than a character string of a true purchase amount 9 (a digit string or the like) in an image captured by a camera depending upon the environment of a store 1.

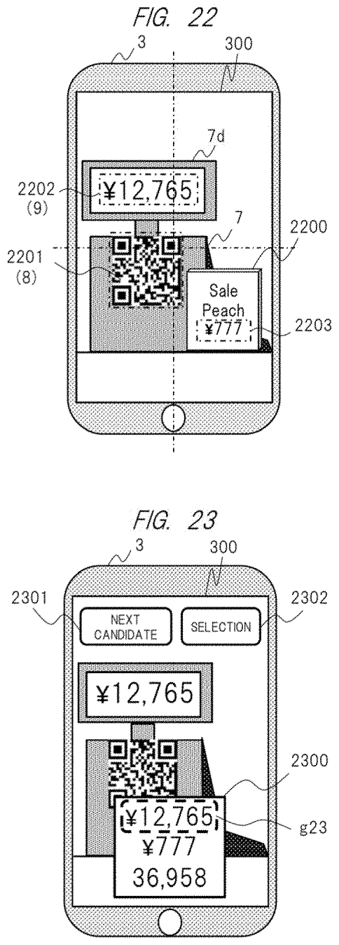

A display screen 300 of an information terminal 3 illustrated in FIG. 22 shows an example of an image in a case where the vicinity of a store terminal 7 in the store 1 is photographed by a camera 30. In the present embodiment, there is an advertising matter 2200 near a QR code 8 and a purchase amount 9 posted on the store terminal 7. In addition to an area 2201 for the QR code 8 and an area 2202 for the purchase amount 9, a character string 2203 (for example, an amount of a sales product) described in the advertising matter 2200 is captured in this image. In such a case, it is necessary to recognize a correct purchase amount 9 from a plurality of character strings in the image.

In FIG. 21, Step S14 for recognizing a payment amount has Steps S91, S92, S93, and S94. At Step S91, the information terminal 3 scans and detects character strings from an image photographed by a camera. At this time, in the image example illustrated in FIG. 22, a character string in an area 2202 for a purchase amount 9 and a character string 2203 in an advertising matter 2200 are detected as candidates. At the time of Step S91, for example, the information terminal 3 searches character string(s) in an area of the image photographed by the camera while moving a rectangular area having a smaller size than that of the character string, and detects digit string(s) included in the rectangular area as candidate character string(s).

Note that in a case where the information terminal 3 cannot recognize any digit string from the photographed image, as an exceptional process, the information terminal 3 may use an audio recognizing function to determine a digit string read by a clerk 5 or a purchaser 2 by voice as a candidate character string for a purchase amount 9. For example, the information terminal 3 may output a guidance to the purchaser 2 or the like so as to read it by voice in a case where it cannot be recognized from an image. As described above, the form in which the audio recognition is used separately from the image recognition is also possible. Further, it is not limited to this, and a form in which audio recognition by an audio input is executed from the beginning in parallel with the recognition of the purchase amount 9 from the image photographed by the camera may be used. In a case where the store 1 is a manned store and voice information by the clerk 5 can be used, it can be used supplementally.

Step S92 is a step of a process of evaluating whether the candidate character string detected at Step S91 corresponds to the true purchase amount 9 or not. In detail, Step S92 has Steps S92A to S92E corresponding to an item A to an item E, for example. Each of these steps is a step of evaluation processing for each evaluation item. The information terminal 3 executes the evaluation processing for each evaluation item for each candidate character string, and calculates a score that is an evaluation value for each. The number of evaluation items and the processing content thereof are not limited to these, and the number of evaluation items may be larger or smaller. Further, as a result of trying the evaluation processing, items that could not evaluated may occur.

The evaluation processing for the item A at Step S92A is evaluation processing regarding whether there is something like the store terminal 7 (or a display device 7b) in a background of the image photographed by the camera, which includes a digit string (a candidate character string) to be evaluated. Alternatively, the evaluation processing is evaluation processing regarding the closeness of a distance between the candidate character string and a portion such as the store terminal 7 or the like in the vicinity thereof. At the time of this evaluation processing, the information terminal 3 may use data on a shape or color of the store terminal 7 (or the display device 7b). For example, in a case where the store terminal 7 is captured in the background of the candidate character string, a score of this item A is set to be higher.

The evaluation processing for the item B at Step S92B is evaluation processing regarding whether there is a specific symbol, for example, a currency symbol (for example, “¥” or “yen”) before or after the candidate character string in the image or not. At the time of this evaluation processing, the information terminal 3 executes the evaluation processing on the basis of recognition target format information containing the specific symbols set in advance.

The evaluation processing for the item C at Step S92C is evaluation processing regarding whether they are equal to or similar to each other or not in a case where there is a digit string that is read by the clerk 5 or the purchaser 2 by voice and inputted as a voice recognition result with respect to the candidate character string in the image.

The evaluation processing for the item D at Step S92D is evaluation processing regarding whether a position of the candidate character string in the image is close to a position of the recognized QR code 8 or not. As illustrated in FIG. 22, in case of a configuration in which the purchase amount 9 and the QR code 8 are arranged at positions close to each other to an extent in the store 1, this evaluation processing for the item D is executed. For example, the closer the position of the detected candidate character string is to the position of the recognized QR code 8, the higher a score of this item D is set to be.

The evaluation processing for the item Step S92E is evaluation processing regarding whether a position of the candidate character string in the image of the camera 30 is close to a central position of the image of the camera 30 or not. The closer it is to the central position, the higher a score of this item E is set to be.

Step S93 is a step of a process in which a comprehensive score, in other words, a comprehensive evaluation value is calculated on the basis of the score of each evaluation item for each candidate character string, which is a result of the evaluation at Step S92, and a character string, which is estimated to be most equivalent to the purchase amount 9, is determined and selected from the comprehensive score. At Step S93, the information terminal 3 calculates a score obtained by weighting and adding the scores for each evaluation item for each candidate character string as a comprehensive score, for example. The information terminal 3 selects the maximum value from those each having a comprehensive score threshold value, which is set to be the minimum in advance, or higher in the obtained comprehensive score for each candidate character string, and determines a candidate character string corresponding to the maximum value as one estimated to be the true purchase amount 9. Note that in a case where there are only the candidate character strings each having a value less than the comprehensive score threshold value in the calculated comprehensive score described above, it is determined that there is no true purchase amount 9 in the image, and it is controlled so as to execute evaluation processing from another image.

Step S94 is a step of a process of recognizing a payment amount corresponding to the purchase amount 9 in accordance with the candidate character string of a selection result at Step S93. In the example illustrated in FIG. 22, as a result of the processes up to Step S94, a digit string of the area 2202 is recognized as the purchase amount 9.

[9-2: Effects and the Like]

As described above, according to the nineth embodiment, even in a case where a plurality of character strings is captured in a camera image, it is possible to automatically recognize the true purchase amount 9, and execute the cashless payment.

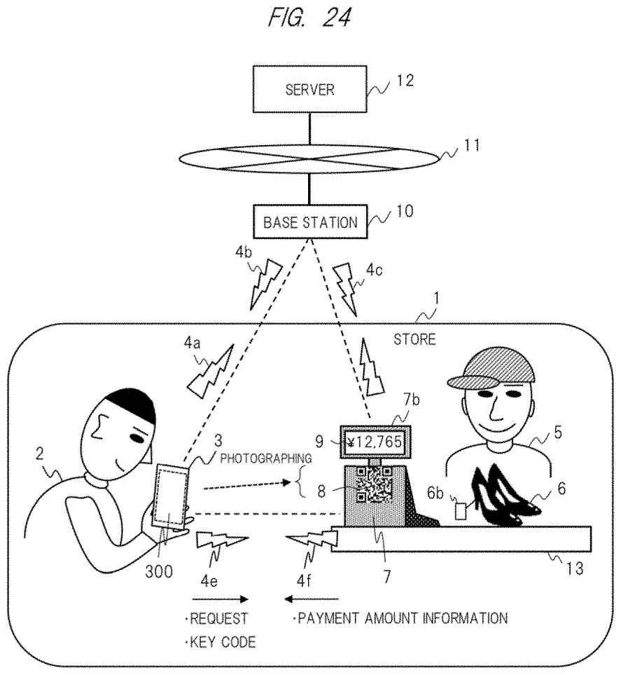

FIG. 23 illustrates an example of the display screen 300 of the information terminal 3 according to a modification example of the nineth embodiment. The information terminal 3 displays some high-ranking candidate character strings (whose value is equal to or more than the comprehensive score threshold value, for example) on this display screen 300 as a purchase amount candidate list 2300 in order of the comprehensive score on the basis of the result of the evaluation processing illustrated in FIG. 21. In the present embodiment, an image of the purchase amount candidate list 2300 is superimposed and displayed in a lower area of the image photographed by a camera. In the present embodiment, in the purchase amount candidate list 2300, three high-ranking candidate character strings are displayed in order of the comprehensive score. A candidate character string “¥12,765” at the top thereof having the highest comprehensive score is in a temporary selection state, for example, and is highlighted with an image g23 such as a frame representing it. The second character string “¥777” and the third character string “36,958” are the other character strings that are captured in an evaluation target image. The purchaser 2 can select and set one character string (for example, “¥12,765”) from the purchase amount candidate list 2300 as the purchase amount 9 by an operation such as a touch operation.

Further, as a modification example, as illustrated in FIG. 23, the information terminal 3 may display a “next candidate” button 2301, a “selection” button 2302, and the like in the display screen 300 as GUI parts. The “next candidate” button 2301 is a button for changing one candidate in the temporary selection state of the plurality of candidates in the purchase amount candidate list 2300 into next candidate (for example, below the one candidate). Note that from the lowest candidate, it returns to the top candidate so as to go round. The “selection” button 2302 is a button for selecting and determining the candidate in the temporary selection state in the purchase amount candidate list 2300 at that time as the purchase amount 9.

As another modification example, in the example of the display screen 300 illustrated in FIG. 22, the information terminal 3 highlights the areas 2202 and 2203 for the respective candidate character strings recognized from a camera image, for example, by attaching an image of a frame thereto. Then, the purchaser 2 selects a portion of the candidate character string that he or she wants to select as the purchase amount 9 from the image of the display screen 300 by an operation such as a touch operation or gaze. The information terminal 3 determines the candidate character string selected by the purchaser 2 through his or her operation as the purchase amount 9. Note that as described above, when the purchase amount 9 is to be recognized from the image photographed by the camera in the display screen 300, it may be a state where a portion of the QR code 8 that has been recognized is not shown in the image.

### Tenth Embodiment

A tenth embodiment of the present invention will be described with reference to FIG. 24 to FIG. 26. The tenth embodiment illustrates a configuration example in which Part of communication is executed between an information terminal 3 and a store terminal 7.

[10-1: Cashless Payment System]

FIG. 24 illustrates a configuration of a cashless payment system according to the tenth embodiment. This configuration is substantially similar to that illustrated in FIG. 1, but as a different configuration point, there is a point that communication regarding part of information is executed between the information terminal 3 and the store terminal 7. In the present embodiment, the information terminal 3 obtains payment amount information from the store terminal 7 by short-range wireless communication, for example. This payment amount information is information regarding a purchase amount 9 (or a corresponding payment amount). A signal 4e and a signal 4f are signal examples at the time of the communication. The signal 4e is a signal in a case where a request of the payment amount information is transmitted from the information terminal 3 to the store terminal 7, or a signal in a case where key code information is transmitted. The signal 4f is a signal in a case where the payment amount information is transmitted from the store terminal 7 to the information terminal 3 as a response.

Further, in the tenth embodiment, as an image photographed by a camera 30 of the information terminal 3 a QR code 8 may at least be captured, and it is not essential to photograph the purchase amount 9 displayed on a display device 7b. For example, the information terminal 3 recognizes only the QR code 8 from the image of the camera to obtain the payment destination information. Note that information for accessing the store terminal 7 from the information terminal 3 by communication (for example, a communication ID or the like of the store terminal 7) may be described in the QR code 8.

Further, in the tenth embodiment, at the time of display of payment processing completion confirming information on the information terminal 3, information on the key code described above (for example, the key code 25 illustrated in (B) of FIG. 2) may be transmitted to the store terminal 7 by the short-range wireless communication described above. The store terminal 7 displays the received key code on a display screen on a clerk 5 side.

[10-2: Processing Flow]

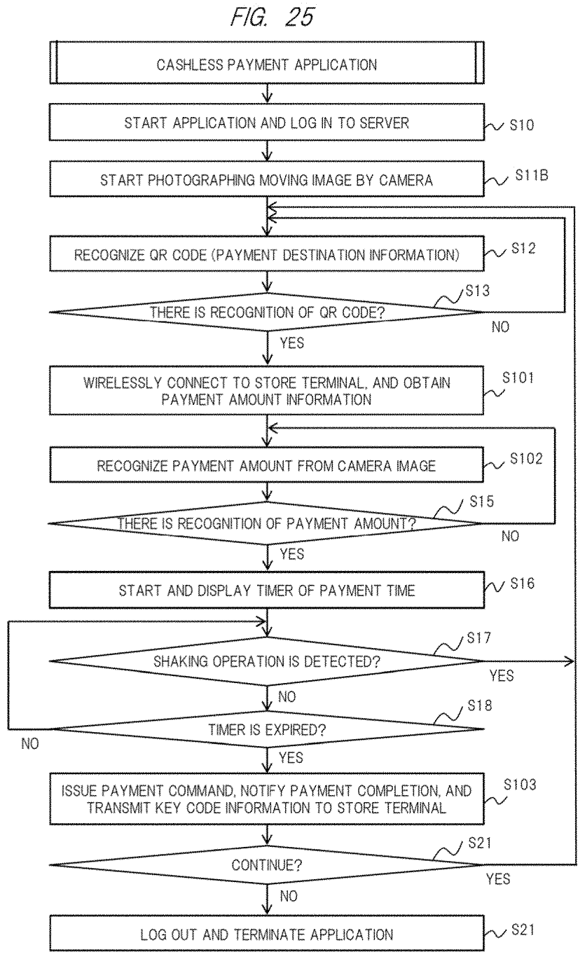

FIG. 25 illustrates a processing flow of the information terminal 3 according to the tenth embodiment. The flow illustrated in FIG. 25 has Steps S101, S102, and S103 as different points from the flow illustrated in FIG.

6. For example, at Step S11B, the information terminal 3 starts photographing a moving image by the camera 30. At Step S12, the information terminal 3 recognizes a QR code from an image photographed by the camera, and obtains payment destination information and the like. In a case where the QR code 8 can be recognized (S13—YES), at Step S101, the information terminal 3 automatically requests wireless connection with the store terminal 7 by short-range wireless communication by using a communication ID or the like of the store terminal 7. BlueTooth (registered trademark) can be used for the communication at this time, for example. The wireless connection between the information terminal 3 and the store terminal 7 is established on the basis of this wireless connection request. On the basis of the establishment, the information terminal 3 transmits a request for payment amount information to the store terminal 7 as a signal 4e. In response to the request, the store terminal 7 transmits Payment amount information containing a payment amount by a total of one or more purchase amounts 9 read by the store terminal 7 to the information terminal 3 as a response signal 4f. The information terminal 3 receives and obtains the payment amount information, and grasps it as the payment amount. The information terminal 3 may display the information on the payment amount obtained from the store terminal 7 on a display screen 300.

Further, at next Step S102, the information terminal recognizes a character string of a purchase amount 9 displayed on the display device 7b of the store terminal 7 from the image photographed by the camera 30. In a case where the character string of the purchase amount 9 can be recognized, the information terminal 3 may obtain the character string of the purchase amount 9, and display image information on the display screen 300. It may be configured so that this Step S102 is omitted.

Then, at Step S15, the information terminal 3 confirms whether a payment amount for using cashless payment processing can be recognized and obtained or not. In a case where it can be recognized and obtained (YES), the processing flow proceeds to Step S16. In a case where it cannot be recognized and obtained (NO), the processing flow returns to Step S102. In particular, the information terminal 3 may compare the payment amount obtained from the store terminal 7 at Step S101 with the payment amount obtained from a camera image at Step S102, and confirm whether they match with each other or not. In a case where they do not match with each other, there is a possibility that one information is incorrect. Therefore, the information terminal 3 may cause the processing flow to return to Step S102 or Step S101, or the first step, and redo the processes again.

At Step S16, the information terminal 3 displays a payment time 20 on the display screen 300. Steps S17 and S18 are similar processes to those described above. Then, at Step S103, the information terminal 3 issues a payment command, and receives payment processing completion confirming information from the server 12 to display it on the display screen 300. Further, the information terminal transmits, to the store terminal 7, information containing a key code of the payment processing completion confirming information as a signal 4e. At this time, key code information to be transmitted to the store terminal 7 may be character information or image information. The store terminal 7 displays the key code obtained from the information terminal 3 on a display screen on the clerk 5 side. As a result, the clerk 5 can confirm payment processing completion by looking at the key code.

[10-3: Display Screen]

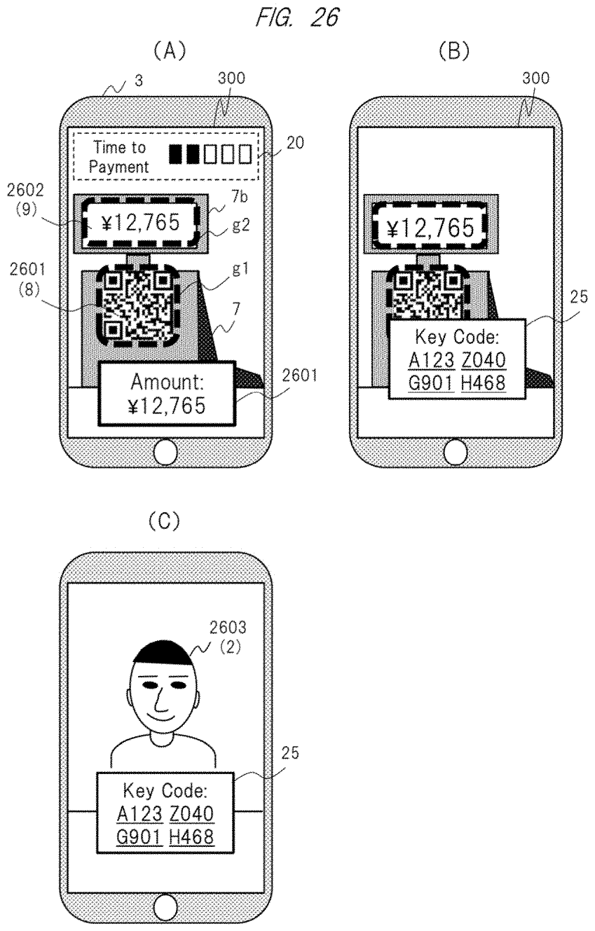

FIG. 26 illustrates an example of the display screen 300 of the information terminal 3. An example of the display screen 300 illustrated in (A) is an example in a case where the payment amount information obtained from the store terminal 7 at Step S101 is displayed. In the present embodiment, an image 2601 of a payment amount based on the Payment amount information obtained from the store terminal 7 is superimposed and displayed in a lower area of an image photographed by the camera in which a QR code 8 and a purchase amount 9 on the display device 7b are captured, for example. Similarly, in a case where the information terminal 3 recognizes the purchase amount 9 at Step S102, the information terminal 3 may display the recognized character string on the display screen 300.

An example of the display screen 300 illustrated in (B) is an example in which a key code 25 in the payment processing completion confirming information obtained from the server 12 is displayed, and this key code 25 corresponds to a key code to be transmitted from the information terminal 3 to the store terminal 7. In the present embodiment, an image of the key code 25 is superimposed and displayed on an image in which a state of the inside of a store 1 viewed from the camera 30 of the information terminal 3, in particular, a state including the store terminal 7 and the purchase amount 9 of the display device 7b is photographed.

An example of the display screen 300 illustrated in (C) is another display example regarding the key code 25. This image example of the display screen 300 is an image in which a state including a face 2603 of a purchaser 2 himself or herself is photographed by the purchaser 2, and an image of the key code 25 is superimposed and displayed on the image.

The information terminal 3 transmits the key code information containing the image illustrated in any of (B) and (C) to the store terminal 7, for example. Note that in the above, the information to be transmitted from the information terminal 3 to the store terminal 7 may be only the character information or the image information of the key code 25, may be one in which the image of the key code 25 is superimposed on the image photographed by the camera, or may be a set of these kinds of information.

In a case where information on the image of the key code as illustrated in (B) or (C) is viewed from the clerk 5 side, a case where the face 2603 of the purchaser 2 is reflected as illustrated in (C) is unlikely to mistake a person, and reliable confirmation is possible. However, in case of a user who is reluctant to provide his or her face image to the store 1 side or a device, such as an HMD, which cannot photograph the user's face image, a key code image as illustrated in (B) may be transmitted. The image illustrated in (B) is an image of a positional relationship when the store terminal 7 or the clerk 5 is viewed from a position where the purchaser 2 is standing. For that reason, at the time of confirmation, the clerk 5 can confirm that it is communication from the user (the purchaser 2) in front of him or her, that is, that the user is a correct payment target person from the positional relationship that can be seen from this image.

### Eleventh Embodiment

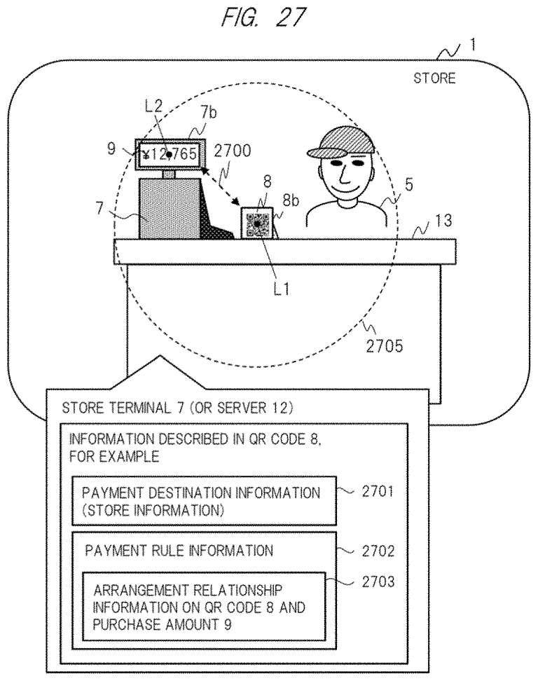

An eleventh embodiment of the present invention will be described with reference to FIG. 27. The eleventh embodiment is a modification example of the first embodiment and the like, and illustrates a case where an arrangement relationship between a QR code 8 and a purchase amount 9 is used. FIG. 27 illustrates an example of a store 1 according to the eleventh embodiment. In the present embodiment, on a checkout counter 13, the QR code 8 is not posted on a store terminal 7, and the QR code 8 is posted on a medium 8b installed near the store terminal 7.

In the eleventh embodiment, with respect to two elements of the QR code 8 and the purchase amount 9 (or a corresponding payment amount), which are used at the time of a cashless payment, an arrangement relationship 2700 of the two elements in a space is defined in advance when an image is photographed and recognized by a camera 30 of an information terminal 3. This arrangement relationship 2700 is an arrangement relationship in a direction when the store terminal 7 or a clerk 5 is viewed from the information terminal 3 side of a purchaser 2. In the eleventh embodiment, such an arrangement relationship 2700 is provided as a condition. In this regard, for details, each method as follows can be applied, for example.

[11-1: First Method]

As one of rules in a first method for a cashless payment, the arrangement relationship 2700 between the two elements of the QR code 8 and the payment amount 9 is fixedly set in advance. Namely, the rules including this arrangement relationship 2700 are similarly applied to all stores 1 that are application targets of this method. A plan view in a direction when the store terminal 7 is viewed from the information terminal 3 of the purchaser 2, in particular, the camera 30, for example, a plan view as illustrated in FIG. 27 is considered. In this plane, the arrangement relationship 2700 between a position L1 of the QR code 8 and a position L2 where the purchase amount 9 is displayed is defined. This arrangement relationship 2700 is described as arrangement relationship information 2703, which is one item of payment rule information 2702 described in the QR code 8, for example. Payment destination information (store information) 2701 and the payment rule information 2702 may be described in the QR code 8 in this manner. Namely, the information terminal 3 obtains these kinds of information by recognition from the QR code 8. Alternatively, the payment rule information 2702 may be associated with the payment destination information 2701, and may be held in the server 12 illustrated in FIG. 1. The information terminal 3 and the store terminal 7 refer to the payment rule information 2702 as a rule when a procedure is executed by this cashless payment method.

The arrangement relationship between the position L1 of the QR code 8 and the position L2 of the purchase amount 9 is described in the arrangement relationship information 2703. In the example illustrated in FIG. 27, it is defined that the position L2 of the purchase amount 9 is substantially in a diagonally upper left direction in a case where the position L1 of the QR code 8 (that is, a position recognized in the image) is used as a reference. Moreover, a distance from the position L1 to the position L2 may also be defined as one of the conditions. For example, a condition that the position L2 is within a range 2705 of a predetermined distance from the position L1 is described in the arrangement relationship information 2703.

For example, similar to the first embodiment, the information terminal 3 first recognizes the QR code 8 from a photographed image of the camera 30, and obtains the payment destination information 2701 and the like. Next, when the purchase amount 9 is recognized from the photographed image, the information terminal 3 refers to the arrangement relationship information 2703 of the payment rule information 2702, and executes recognition processing for the purchase amount 9 in accordance with the definition. For example, the information terminal 3 searches diagonally upward to the left from the position L1 in which the QR code 8 in the photographed image is recognized in accordance with the arrangement relationship 2700, and finds a candidate character string corresponding to the purchase amount 9. In a case where a plurality of character strings is found in the photographed image, the information terminal 3 may select one with the highest possibility as the purchase amount 9 in light of the conditions of the arrangement relationship 2700.

As another example, in a case where the purchase amount 9 is first recognized like the eighth embodiment, the provision of the arrangement relationship 2700 may be a condition regarding the position L1 of the QR code 8 based on the position L2 of the purchase amount 9. Further, as an example of other conditions, the position L2 may be on an upper side with respect to the position L1 of the QR code 8, or the position L2 may be on a right side with respect to the position L1 of the QR code 8. Further, as an example of still other conditions, a character string closest to the position L1 in the range 2705 may be selected, or a character string closest to the i-th position may be selected.

[11-2: Second Method]

As a second method, payment rules including an arrangement relationship 2700 may be set for each store 1. For example, payment destination information (store information) 2701 and payment rule information 2702 set for a store 1 are obtained from a QR code 8 in the store 1. The information terminal 3 refers to arrangement relationship information 2703 in the payment rule information 2702. Alternatively, the information terminal 3 may obtain the payment rule information 2702 for the store 1 on the basis of the payment destination information 2701 obtained from the QR code 8 by communication with the server 12 or the store terminal 7. In case of the second method, a suitable rule can be set for each store 1.

As a modification example, it is also possible to set different payment rule information 2702 for each product 6. For example, it is also possible to set different payment rule information 2702 for each type of product 6 or high and low of the purchase amount 9. As described above, the payment rule information 2702 can also be provision regarding a processing flow, and it is also possible to set necessity of login according to a required security level or a length of a payment time 20.

[11-3: Effects and the Like]

As described above, since there is the condition of the arrangement relationship 2700 related to the recognition processing in the eleventh embodiment, the information terminal 3 may be able to more efficiently recognize the purchase amount 9 and the like from the photographed image. For example, since the number of candidate character strings can be reduced, it is possible to expect effects such as speeding up of the recognition processing, and shortening of a cashless payment.

As described above, the present invention has specifically been described on the basis of the embodiments. However, the present invention is not limited to the embodiments described above, and the present invention may be modified into various forms without departing from the substance thereof. The components of each of the embodiments can be added or deleted, replaced, or combined. A part or all of the functions described above may be implemented by hardware, or may be implemented by software program processing. Programs or data constituting the functions may be stored in a computer-readable storage medium, or may be stored in an apparatus on a communication network. In the embodiments, a case where the cashless payment is used to pay a purchase amount of a product in a store has been described. However, it is not limited to this. For example, it can be applied in various situations such as payment for traffic violations, payment at vending machines, and payment for interpersonal sales.

### REFERENCE SIGNS LIST

1 . . . store, 2 . . . purchaser (user), 3 . . . information terminal (cashless payment terminal), 5 . . . clerk, 6 . . . product, 7 . . . store terminal, 7b . . . display device, 8 . . . QR code, 9 . . . purchase amount, 10 . . . base station, 11 . . . network, 12 . . . server (payment application server), 13 . . . checkout counter, 30 . . . camera, 41 . . . application (cashless payment application).

1. A cashless payment system for executing cashless payment associated with purchase of a product or service by a user at a store, an information terminal having a camera and a cashless payment function being connected by communication to a server executing cashless payment processing in the cashless payment system, the user who is a purchaser using the information terminal,
wherein the information terminal is configured to:
photograph, by the camera, a code of payment destination information posted by the store and a payment amount corresponding to a purchase amount of the product or service on a basis of an operation of the user;
issue a payment command in a case where both the payment destination information and the payment amount are recognized on a basis of a photographed image, the payment command including the payment destination information and the payment amount; and
transmit the payment command to the server to cause the server to execute the cashless payment processing.

2. The cashless payment system according to claim 1,
wherein the server is configured to transmit payment processing completion confirming information to the information terminal after the cashless payment processing is completed, and
wherein the information terminal is configured to output the payment processing completion confirming information to the user.

3. The cashless payment system according to claim 1,
wherein the information terminal is configured to:
start counting a timer for a payment time of a set length from a time when both the payment destination information and the payment amount are recognized;
display an image of the payment time on a display screen; and
issue the payment command after the timer for the payment time is expired.

4. The cashless payment system according to claim 1,
wherein the information terminal is configured to recognize both the payment destination information and the payment amount on the basis of the photographed image in which the code and the payment amount are captured simultaneously.

5. The cashless payment system according to claim 1,
wherein the information terminal is configured to recognize the payment destination information from a first image in which the code is captured, and then recognize the payment amount from a second image in which the payment amount is captured.

6. The cashless payment system according to claim 1,
wherein the information terminal is configured to recognize the payment amount from a first image in which the payment amount is captured, and then recognize the payment destination information from a second image in which the code is captured.

7. The cashless payment system according to claim 1,
wherein the information terminal is configured to:
recognize a purchase amount of an individual product or service from the photographed image at a time of one cashless payment regarding purchase of a plurality of products or services;
start counting a timer for a payment time of a set length each time the payment amount as a total is displayed;
display an image of the payment time on a display screen; and
issue the payment command after the timer for the payment time is expired.

8. The cashless payment system according to claim 3,
wherein, in a case where the information terminal detects a predetermined cancellation operation by the user in a middle of the payment time, the information terminal is configured not to issue the payment command.

9. The cashless payment system according to claim 2,
wherein the information terminal is a head mounted display.

10. The cashless payment system according to claim 2,
wherein a head mounted display and a wearable terminal are provided as the information terminal,
wherein the head mounted display is configured to transmit the payment command to the server, and
wherein the wearable terminal is configured to display the payment processing completion confirming information.

11. The cashless payment system according to claim 9,
wherein the head mounted display is configured to transmit the payment command in a case where a first gesture by the user is detected after both the payment destination information and the payment amount are recognized, and
wherein the head mounted display is configured not to issue the payment command in a case where a second gesture is detected.

12. The cashless payment system according to claim 1,
wherein the information terminal is configured to:
calculate an evaluation point for each evaluation item in a plurality of evaluation items regarding whether each candidate character string extracted from the photographed image is the payment amount or not when the payment amount is recognized from the photographed image,
calculate a comprehensive evaluation point from the plurality of evaluation points;
select, as the payment amount, a candidate character string having a highest value at a threshold value or more among the comprehensive evaluation points of the respective candidate character strings; and
output a result that the payment amount cannot be recognized in a case where there is no candidate character string that becomes the threshold value or more.

13. The cashless payment system according to claim 1,
wherein the information terminal is configured to:
display an image representing candidate character strings extracted from the photographed image on a display screen when the payment amount is recognized from the photographed image; and
select, as the payment amount, a candidate character string selected from the candidate character strings on a basis of an operation of the user.

14. The cashless payment system according to claim 1,
wherein there is a store terminal having a payment function in the store, and
wherein the information terminal is configured to:
wirelessly communicate with the store terminal to obtain payment amount information regarding the payment amount from the store terminal;
confirm whether the payment amount recognized from the photographed image matches a payment amount in the payment amount information or not; and
issue the payment command in a case where both the payment destination information and the payment amount are recognized.

15. The cashless payment system according to claim 2,
wherein there is a store terminal having a payment function in the store, and
wherein the information terminal is configured to:
wirelessly communicate with the store terminal to transmit data containing a payment completion ID in the payment processing completion confirming information to the store terminal.

16. The cashless payment system according to claim 1,
wherein an arrangement relationship between a first position where the code is posted in the store when viewed from the purchaser and a second position where the payment amount is posted is defined in advance, and
wherein the information terminal is configured to recognize both the payment destination information and the payment amount from the photographed image on a basis of provisions of the arrangement relationship.

17. An information terminal in a cashless payment system for executing cashless payment associated with purchase of a product or service by a user at a store, an information terminal having a camera and a cashless payment function being connected by communication to a server executing cashless payment processing in the cashless payment system, the user who is a purchaser using the information terminal,
wherein the information terminal is configured to:
photograph, by the camera, a code of payment destination information posted by the store and a payment amount corresponding to a purchase amount of the product or service on a basis of an operation of the user;
issue a payment command in a case where both the payment destination information and the payment amount are recognized on a basis of a photographed image, the payment command including the payment destination information and the payment amount; and
transmit the payment command to the server to cause the server to execute the cashless payment processing.
